(19) United States
(12) Patent Application Publication
(10) Pub. No.: US 2005/0026301 A1
(43) Pub. Date: Feb. 3, 2005

(54) Method and apparatus for controlling fluid movement in a microfluidic system

(76) Inventor: Henry Petithory, Westboro, MA (US)

Correspondence Address: Martin L. McGregor, 26415 Oak Ridge Dr., Spring, TX, 77380, US

(21) Appl. No.: 10/924,140

(22) Filed: Aug. 23, 2004

Related U.S. Application Data
(63) Continuation-in-part of application No. 10/396,280, filed on Mar. 24, 2003, now abandoned.
(60) Provisional application No. 60/368,113, filed on Mar. 25, 2002.

(51) Int. Cl. G01N 1/10

(52) U.S. Cl. 436/180; 422/100

(57) ABSTRACT

The invention provides a method for moving a fluid sample within an open channel flow device by centrifugal force and specially adapted apparatus for practicing the method of the invention. The inventive method is a mechanically simple method for moving a fluid in a platform by changing the orientation of a platform relative to the direction of applied forces when the centrifuge rotor is at rest in order to move a fluid sequentially through a plurality of chambers, wherein movement of the fluid is controlled by the location or size of the passages connecting chambers relative to the direction of forces acting on the fluid.

### RELATED APPLICATIONS

This application is a section 371 national phase application from PCT international application Serial Number PCT/US03/09162PCT Filed 24 Mar. 2003., claiming priority from U.S. provisional application Ser. No. 60/368,113 filed Mar. 25, 2002, and U.S. application Ser. No. 10/396,280. filed 24 Mar. 2003, now abandoned

### TECHNICAL FIELD

This invention relates to chemical or biological tests and procedures in microfluidic apparatus, and specifically to a microfluidic platform mounted on a centrifuge rotor adapted to carry out chemical, biological or biochemical tests or processes.

### BACKGROUND OF THE INVENTION

There are numerous systems for carrying out small scale chemical tests or processes. See for example U.S. Pat. Nos. 4,812,294, 4,814,282 4,883,763, 4,776,832, 5,696,233, 5,639,428 and 6,302,134. The devices described therein emphasize manipulation of chemical samples in small platforms wherein fluids are moved from one chamber to another by applied forces past check or burst valves by centrifugal force, several of the patents disclose complex electrical or electromechanical systems to change the position of a reaction vessel in a moving centrifuge rotor. However heretofore the art has not taught the use of a simple open channel microfluidic system wherein a specially adapted rotor is used to change orientation of the microfluidic plate when the centrifuge rotor is at rest thereby controlling movement of fluids within the microfluidic device, in combination with a simple open channel or valve less microfluidic platform having passages positioned and shaped to allow or inhibit flow by reorientation of the platform in a single plane.

### SUMMARY OF THE INVENTION

The invention provides a method for moving a fluid sample within an open channel flow device by centrifugal force which comprises providing a planar platform having a plurality of chambers, having a first chamber with a plane, a fluid passage in the plane of the plurality of chambers, each fluid passage having a first and a second end, the first end in fluid communication with the first chamber, a second chamber in fluid communication with the second end of the fluid passage, and a second fluid passage in the plane of the plurality of chambers, having a first and a second end the first end in fluid communication with the second chamber and a third chamber in fluid communication with the second end of the second fluid passage the position or shape of each fluid passage creating a flow restricting action in a first position and a flow enhancing action in a second position by reorientation of the platform while connecting the first, second and third chambers to enable sequential movement of a fluid from the first chamber to the second chamber in a first orientation of the platform such that centrifugal force is applied in a flow enhancing direction to move fluid through the first passage from the first chamber to the second chamber and following a change in orientation of the platform to enable further movement of the fluid from the second chamber to the third chamber, placing the open channel flow device in a centrifuge, positioning the open channel flow device such that a fluid placed in the first chamber will not move by centrifugal force from the first chamber to the second chamber when the open channel flow device is a first position, stopping the application of centrifugal force and thereafter positioning the open channel flow device in a second position wherein fluid moves from the first chamber to the second chamber during operation of the centrifuge, the second position being achieved by rotation of the planar platform around an axis of rotation placed at an angle greater than zero to the plane of the platform, applying a centrifugal force to the platform for sufficient time to move the fluid from the first chamber to the second chamber, stopping the application of centrifugal force, thereafter positioning the open channel flow device in a third position such that the fluid in the second chamber will move by centrifugal force from the second chamber to the third chamber, and applying a centrifugal force for sufficient time to move the fluid from the second chamber to the third chamber, the third position being achieved by rotation of the planar platform around an axis of rotation placed at an angle greater than zero to the plane of the platform.

In a preferred embodiment the invention further comprises providing at least one fluid passage having a shape that increases the time required to move the fluid from one chamber to another over the time required to move the fluid between the same chambers by a passage following the shortest path between the chambers. In another preferred embodiment the invention further comprises providing a plurality of chambers and connecting passages are provided such that two fluids are moved to the same chamber. Preferably one chamber is provided that has a shape that increases mixing of two fluids entering the chamber, for example a chamber is provided that has internal baffles to increase mixing. In another preferred embodiment the invention further comprises a method wherein a passage is provided that prevents flow by a size that prevents flow of a fluid through the passage in the absence of a force applied to the fluid in the direction of the passage. In a preferred embodiment the method further comprises a step wherein a passage is provided that prevents flow by the location of the passage relative to the direction of forces acting on the fluid in the chamber in a first position and allows flow when the platform is rotated to a second position relative to forces acting on the fluid. In a preferred embodiment the method further comprises a step wherein the chambers and passages are arranged such that fluid moves sequentially from the first chamber to the second chamber and from the second chamber to the third chamber but the fluid does not move in the reverse sequence from the second chamber to a previously occupied chamber. In an especially preferred embodiment the method further comprises a step wherein a chamber is provided that is sized to measure a quantity of fluid and a passage is provided to move excess fluid to an additional chamber. In a preferred embodiment the method further comprises a step wherein a passage is provided to move the measured quantity of fluid to a third chamber and means are provided to contact the measured quantity with a substance in the third chamber that produces a change in at least one component of the measured quantity of fluid. In a preferred embodiment the method further comprises a step wherein a passage is provided having a surface in contact with the fluid to be moved that is treated to reduce the attraction between the surface and the fluid.

Alternatively the invention can be embodied as a valve-less fluidic device comprising a centrifuge rotor having mounted there on a platform having a first chamber, a second chamber and a third chamber within a plane, a plurality of fluid passages in same plane as two of the chambers the first, second and third chamber and second chambers, each fluid passage having a first end and a second end, a first fluid passage having the first end in fluid communication with the first chamber and the second end in fluid communication with the second chamber and a second the first fluid passage being positioned and shaped such that fluid communication is established between the first and second chambers when the platform is placed in a first orientation to the direction of applied centrifugal force and prevents fluid flow when the platform is rotated around its axis at an angle greater than zero to the plane of the fluid passage to a second position wherein fluid does not flow through the passage when centrifugal force is applied to the platform, and a second fluid passageway having a first end in fluid communication with the second chamber and the second end in fluid communication with the third chamber such that fluid communication is established between the second and third chambers when the platform is placed in a second orientation to the direction of applied centrifugal force and prevents fluid flow form the second chamber to the first chamber when the platform is rotated around its axis at an angle greater than zero to the plane of the fluid passage when centrifugal force is applied to the platform, the, device comprising positioning means for fixing the platform in a plurality of positions and means for moving the platform from a first fixed position to a second fixed position when the rotor is at rest, such that changing the orientation of the platform is conducted in the absence of applied centrifugal force.

In a preferred embodiment the device includes a platform that comprises at least one fluid passage having a shape that increases the time required to move the fluid from one chamber to another over the time required to move the fluid between the same chambers by a passage following the shortest path between the chambers. In another preferred embodiment the device includes a platform that comprises a plurality of chambers and connecting passages such that two fluids are moved to the same chamber. In an alternative embodiment the device has a platform that comprises at least one chamber has a shape that increases mixing of two fluids entering the chamber. In an alternative embodiment the device has a platform wherein a chamber has internal baffles to increase mixing. An especially preferred device has a platform that comprises a passage that prevents flow by having a size that prevents flow of a fluid through the passage in the absence of a force applied to the fluid in the direction of the passage. In an alternative embodiment the device has a platform that comprises a passage that prevents flow by the location of the passage relative to the direction of forces acting on the fluid in the chamber in a first position and allows flow when the platform is rotated to a second position relative to forces acting on the fluid. Alternatively the device platform comprises chambers and passages that are arranged such that fluid moves sequentially from the first chamber to the second chamber and from the second chamber to the third chamber but the fluid does not move in the reverse sequence from the second chamber to a previously occupied chamber regardless of subsequent orientations of the device. Alternatively the device platform comprises a chamber is sized to measure a quantity of fluid and a passage to move excess fluid to an additional chamber. In a preferred embodiment the device platform comprises a passage to move the measured quantity of fluid to a third chamber and means to contact the measured quantity with a substance in the third chamber that produces a change in at least one component of the measured quantity of fluid. A preferred device has a platform that comprises a passage having a surface in contact with the fluid to be moved that is treated to reduce the attraction between the surface and the fluid

In an additional alternative the invention provides a centrifuge for applying centrifugal force to a device comprising a rotor adapted to house a valve free device comprising a platform having at least three chambers within a plane, at least two fluid passages in same plane as at least two of the chambers each fluid passage having a first end and a second end, the first end being in fluid communication with a first chamber, and the second end of the fluid passage being in fluid communication with a second chamber each fluid passage being positioned and shaped such the fluid communication is established between the first and second chambers when the platform is placed in a first orientation to the direction of applied centrifugal force and preventing fluid communication when the platform is rotated around its axis at an angle greater than zero to the plane of the fluid passage to a second position wherein fluid does not flow through the passage when centrifugal force is applied to the platform, and means to stop the rotor, means to reposition the platform by rotating the platform from a first position to a second position when the rotor is at rest.

A preferred centrifuge has a platform that comprises at least one fluid passage having a shape that increases the time required to move the fluid from one chamber to another over the time required to move the fluid between the same chambers by a passage following the shortest path between the chambers. A preferred centrifuge has a platform that comprises a plurality of chambers and connecting passages such that two fluids are moved to the same chamber. A preferred centrifuge has a platform that comprises at least one chamber has a shape that increases mixing of two fluids entering the chamber. A preferred centrifuge has a platform that comprises a chamber has internal baffles to increase mixing. A preferred centrifuge has a platform that comprises a passage that prevents flow by having a size that prevents flow of a fluid through the passage in the absence of a force applied to the fluid in the direction of the passage. A preferred centrifuge has a platform that comprises a passage that prevents flow by the location of the passage relative to the direction of forces acting on the fluid in the chamber in a first position and allows flow when the platform is rotated to a second position relative to forces acting on the fluid. A preferred centrifuge has a platform that comprises chambers and passages that are arranged such that fluid moves sequentially from the first chamber to the second chamber and from the second chamber to the third chamber but the fluid does not move in the reverse sequence from the second chamber to a previously occupied chamber regardless of subsequent orientations of the device. A preferred centrifuge has a platform that a chamber sized to measure a quantity of fluid and a passage to move excess fluid to an additional chamber. A preferred centrifuge has a platform that comprises a passage to move the measured quantity of fluid to a third chamber and means to contact the measured quantity with a substance in the third chamber that produces a change in at least one component of the measured quantity of fluid. A preferred centrifuge has a platform that comprises a passage having a surface in contact with the fluid to be moved that is treated to reduce the attraction between the surface and the fluid.

### BRIEF DESCRIPTION OF THE DRAWINGS

FIG. 1A-B show three dimensional views of a prototype device used in testing the invention.

FIGS. 2A-B illustrate construction of a multi-layer device.

FIG. 3 is an illustration of a centrifuge unit and device representing one embodiment of the invention to perform a complex series of operations on a sample.

FIG. 4 is an illustration of a centrifuge unit and device representing another embodiment of the invention in which multiple samples can be processed simultaneously in parallel operation.

FIG. 5A is an illustration of a centrifuge unit and device representing another embodiment of the invention in which reagents can be added to the device by gravity during the operating cycle.

FIGS. 5B-C show more detail of the operation and construction of the device and centrifuge unit depicted in FIG. 5A.

FIG. 6 is a detailed plan view of the device depicted in FIG. 3.

FIGS. 7A-V illustrate a device of the type depicted FIG. 3 in operation. The lettered drawings show the orientation of the device at various points during the operating cycle and describe movement of fluids under centrifugal force.

FIG. 8 is a plan view of a multi-segmented device of the type depicted in FIG. 4.

FIG. 9 is a detailed plan view of one segment of the device depicted in FIG. 9.

FIGS. 10A-T illustrate a device of the type depicted FIG. 4 in operation. The lettered drawings show the orientation of the device at various points during the operating cycle and describe movement of fluids under centrifugal force.

### DETAILED DESCRIPTION OF THE INVENTION

Microfluidic devices of the invention may be fabricated from any conventional material. Thermoplastics such as perfluroethylene (such as DuPont's Teflon® brand), polyethylene, polypropylene, methylmethacrylates and polycarbonate, among others, are preferred due to their ease of molding, micromachining and stamping. Alternatively, the devices can be made of or can be made in part of silica, glass, quartz or inert metal.

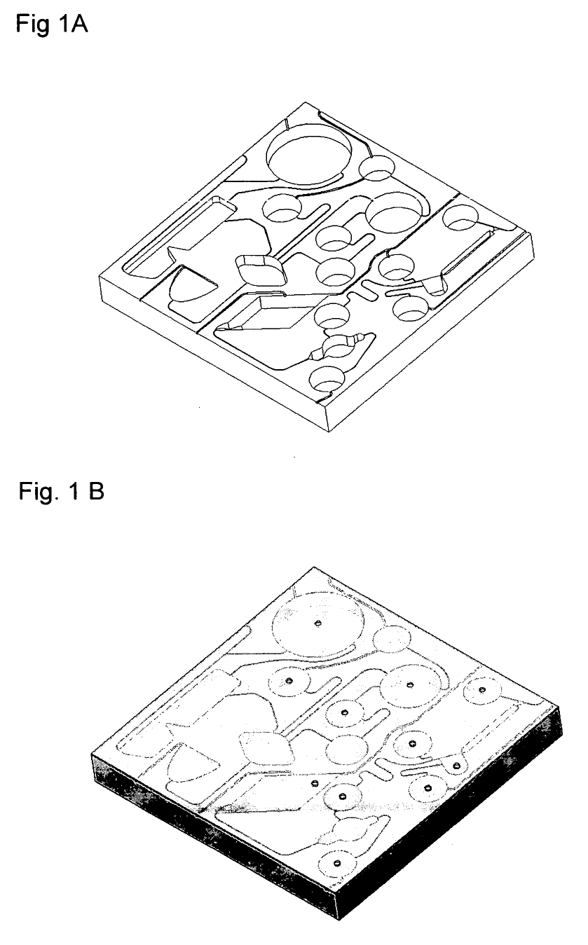

FIG. 1A illustrates a prototype device used to test the invention. The device was machined from a 43 mm×43 mm×6 mm piece of polyoxymetheylene (Delrin® brand polyacetal available from I.E. DuPont and Co., Wilmington, Del.) and included channels and chambers in various formats to simulate three common laboratory procedures: an immunoassay of blood, cell harvesting/washing, and a “spin column” sample enrichment. In order to conserve space on the platform, chambers for fluid wastes and overflows were omitted from the design and fluids were allowed to exit the device. In practice, waste chambers would be integral to the device. FIG. 1B shows the prototype device with a laminate material adhered to the upper surface of the device to seal the channels and chambers machined into the polyacetal substrate. Small holes were cut into the laminate to allow addition of samples and reagents and for venting of a chamber where appropriate.

In practice, chambers and channels in the devices of the invention may be round, trapezoidal, triangular or other geometric shapes as required. Channel and chamber sizes are optimally determined by the application. Channels may be from 0.01 mm to several millimeters deep and from 0.01 mm to several millimeters wide. Channels may be straight, curved, zig-zag or U-shaped depending upon the application and specific function of the channel. For example, a narrow zig-zag shaped channel my be used to delay the flow of fluid from one chamber to another; a U-shaped channel may be used to provide a fluid trap to effectively isolate a connecting chamber from the remainder of the analytical system if desirable. Chambers may be from 0.05 mm to several millimeters deep and from 0.1 to a centimeter or more in diameter. Capacity of the chambers may range from nanoliters to 1 mL or more depending upon the application.

Passages and chamber of the invention are recessed into the surface of a substrate by micromachining, etching, photolithography, electron beam lithography, molding, stamping or the like. The substrate may be of any of a variety of materials, rigid or flexible, optimally chosen to suit the application, and may be any size permitting free flow of fluids under centrifugal forces preferably from 0.1 mm to 100 mm in thickness, ideally in the range of 2-5 mm in thickness. A laminate, preferably a transparent material, is adhered to the surface of the substrate to seal the channels and chambers formed in the substrate. The laminate may be adhered to the substrate by adhesives, glues, heat-sealing, sonic welding or the like. The laminate closure is of sufficient thickness (ideally approximately 10 mil. or more) to inhibit deformation caused by fluid pressure within the device under centrifugal force, and the laminate may include reagent or sample entry or exit ports and vents which are pre-formed on the laminate or cut into the laminate after adhesion to the substrate. The substrate onto which the channels and chambers are formed and the laminate material ideally have hydrophobic surfaces to inhibit unwanted fluid movement in the channels and chambers when the device is a rest under the influence of natural gravitational force. The substrate and laminate materials may if needed be treated by chemical or other means known in the art to enhance hyrophobicity of channel and chamber surfaces.

If non-aqueous fluids are used surfaces may be treated to decrease attraction between the fluid and the surface of the channels or passages. As used herein passage and channel mean the same thing. Where appropriate, the chambers of the invention may be sized and fashioned to minimize the inertia of, and thereby the unintended movement of, a fluid contained within a chamber when the device is under the influence of natural gravitational force, such as between centrifugation cycles. Similarly, in applications involving the processing of fluids with a low surface tension such as solvents, alcohols or detergents, a chamber may be extra deep to minimize possible fluid contact with connecting channels under gravity thereby preventing unwanted capillary action in the channels.

Chambers of the platform may be designed with perturbations such as with internal fins or with other structures to minimize undesirable resuspension of previously sedimented particles upon deceleration and acceleration of the centrifuge rotor. Channels and chambers of the invention may be fitted with separation, purification, or binding media such as filtration membranes, chromatography microbeads and the like, these articles being contained within or bound to the internal surface of chambers or channels.

To increase the density of microfluidic structures contained on the substrate, channels and chambers may be formed on both the upper and lower planar surfaces of the substrate with through-holes to connect channels and chambers of the upper surface with channels and chambers of the lower surface. In this instance, laminate sealing material would be adhered to both planar surfaces of the substrate. Additionally, the microfluidic device may be built by sequential application of layers upon the substrate, the layers being either additional substrates of channels and chambers with through-holes to communicate with channels and chambers of an adjoining substrate, or sealing layers with access ports, vents and appropriate windows for external detection.

The layers may also include laminates of wave guides or electric circuits for external manipulation of the fluid contained within the structure such as heating, cooling or excitation of fluorescent probes, or layers may be structures designed to removeably hold and position external devices such as a microscope slide, coverslip or cuvette which may be desirable to include as part of the sample preparation or analytical process. Ideally, the through-holes in the substrate used to communicate a network of channels and chambers of one substrate with those of another substrate include an integral nozzle structure on the outlet end of the through-hole which projects through one or more laminate surfaces into a channel or chamber of the connecting substrate. In this manner, a leak-free transfer of fluid from channels or chambers of one substrate to channels or chambers of a second substrate can be reliably achieved without need for a liquid tight seal of the through-hole to the adjoining substrate or laminate surface thereby permitting the transfer of fluid from one substrate to another substrate through other layers of the device, such as a layer of wave guides, which may be located between the two substrates.

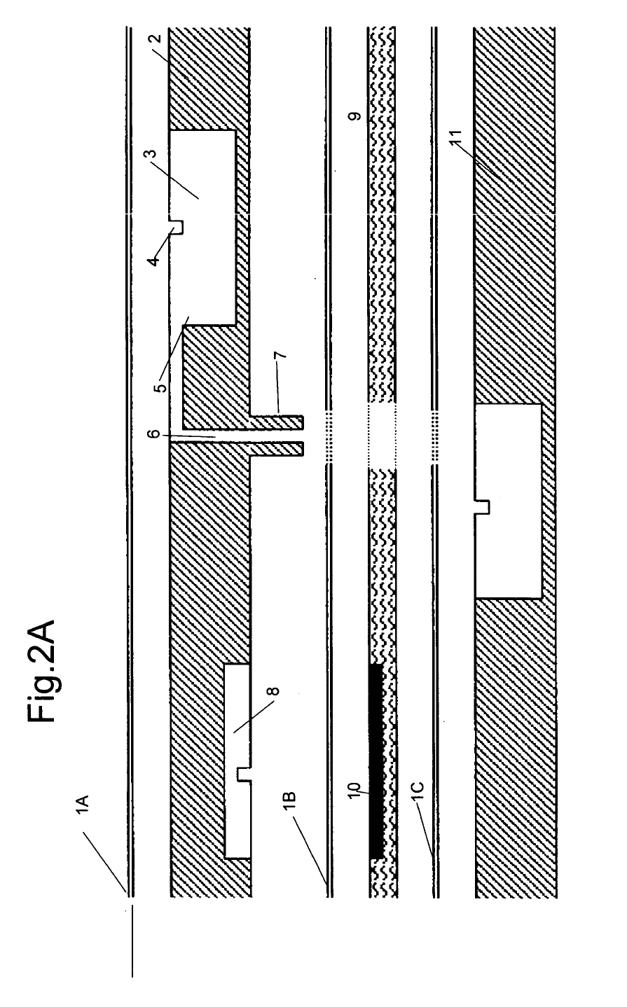

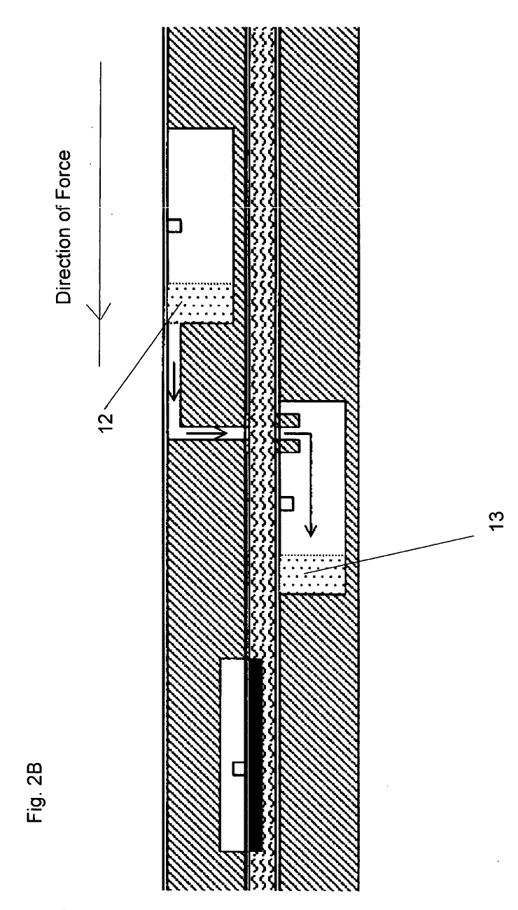

FIGS. 2A and 2B illustrate a segment of a hypothetical multi-layered device. The exploded view 2A shows the various layers and substrates prior to assembly including laminate layers 1a, 1b and 1c, upper substrate 2, electronic layer 9 with heater 10, and lower substrate 11. Substrate 2 includes incubation chamber 8 designed to be in proximity to heater 10 upon assembly and chamber 3 designed to receive a fluid through inlet channel 4 and subsequently transfer its contents through channel 5 and into through-hole 6. A nozzle projection 7 extends through-hole 6 below the lower surface of substrate 2. Substrate 11 includes chamber 12 designed to receive fluid from chamber 3 that under centrifugal force is pumped through channel 5, into through-hole 6 and past nozzle 7. FIG. 2B shows a cross section of the hypothetical device following assembly. Upon application of centrifugal force in the direction shown, fluid contained in location 12 is transferred from the upper chamber past layers of the device to location 13 in the lower chamber.

In certain applications, it may be desirable to prepackage liquid or powdered reagents in the microfluidic platform thereby eliminating the need for the technician to add reagents to the platform manually. In this case, channels connecting the liquid reagent chamber to the analytical path can be reversibly plugged with an inert gel material, such as the gel used in blood serum separation tubes, and the chamber vent of the laminate material may be reversibly sealed with adhesive film. Reagents packaged in this manner can remain stable within the microfluidics platform for extended periods. By removing the vent seal and applying centrifugal force in the appropriate orientation relative to the force vector, a sealed on-board reagent can be introduced into the analytical system.

The centrifuge unit of the invention is designed to removeably hold the open channel microfluidic platform in a specified orientation, apply centrifugal force of specified magnitude and duration to the device in a first orientation, reposition the open channel microfluidic platform to a second specified orientation in the same plane relative to the direction of centrifugal force, this second orientation of the platform being achieved by turning the platform about its own axis while the rotor is at rest, and reapplication of centrifugal force of a specified magnitude and duration. The centrifuging, stopping and reorientation of the microfluidic platform within a single plane continues in a predetermined sequence of steps specifically designed for the microfluidic platform to carry out its function. Ideally, all operations of the centrifuge unit are performed automatically without need for operator intervention. The desired sequence of operating steps may be preprogrammed into centrifuge unit or instructions for the operating sequence may be contained on the microfluidic platform in the form of a bar code or other coding scheme that could be interpreted and implemented by the centrifuge unit.

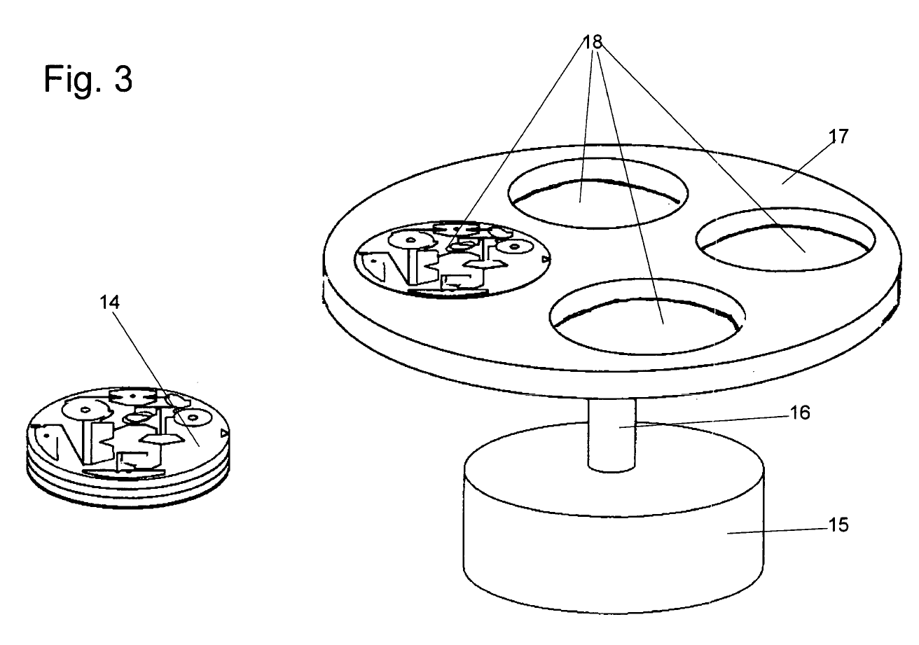

FIGS. 3-5 illustrate three preferred embodiments of the centrifuge unit. For each of these embodiments a large number of possible test and sample processing procedures can be performed using variations of the open channel microfluidic platform described.

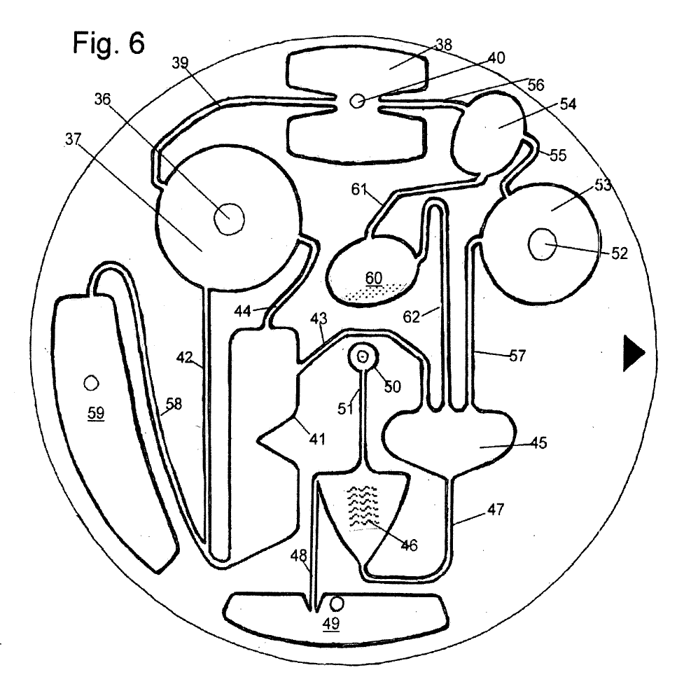

FIG. 3 illustrates a typical microfluidic platform of the invention along with its associated centrifuge unit. The disc-shaped microfluidic platform 14 is designed to perform an immunoassay on blood and is illustrated in greater detail in FIG. 6. The centrifugal processing unit includes a drive motor 15 connected to drive shaft 16. The circular rotor plate 17 connected to drive shaft 16 is generally planar and may be constructed from any material capable of withstanding the stresses generated in centrifugation. The rotor shown includes four carriers 18, each of which includes means to receive a microfluidic platform in a fixed orientation and clamping means (not shown) to hold the platform in place during the operating cycle. In practice a rotor of this type may hold any number of devices that is found useful in a particular application. The microfluidic devices contained by the rotor are oriented in a single horizontal plane positioned at a right angle to the rotor's axis of rotation. Each platform carrier 18 can be rotated horizontally about its own axis when the rotor is not turning to position the microfluidic platform in a specified orientation relative to the direction of the centrifugal force when the rotor is turning. Rotation of the platform carriers can be accomplished by a second motor (not shown) that first engages a ratchet mechanism, gear box or other such mechanism known in the art to rotate the carriers independently or simultaneously to the desired position when the rotor is at rest, then disengages from the rotor mechanism prior to the reapplication of centrifugal force. The embodiment illustrated in FIG. 3 is particularly well suited to process microfluidic platforms designed to perform a complex series of procedures involved in the testing or processing of individual samples.

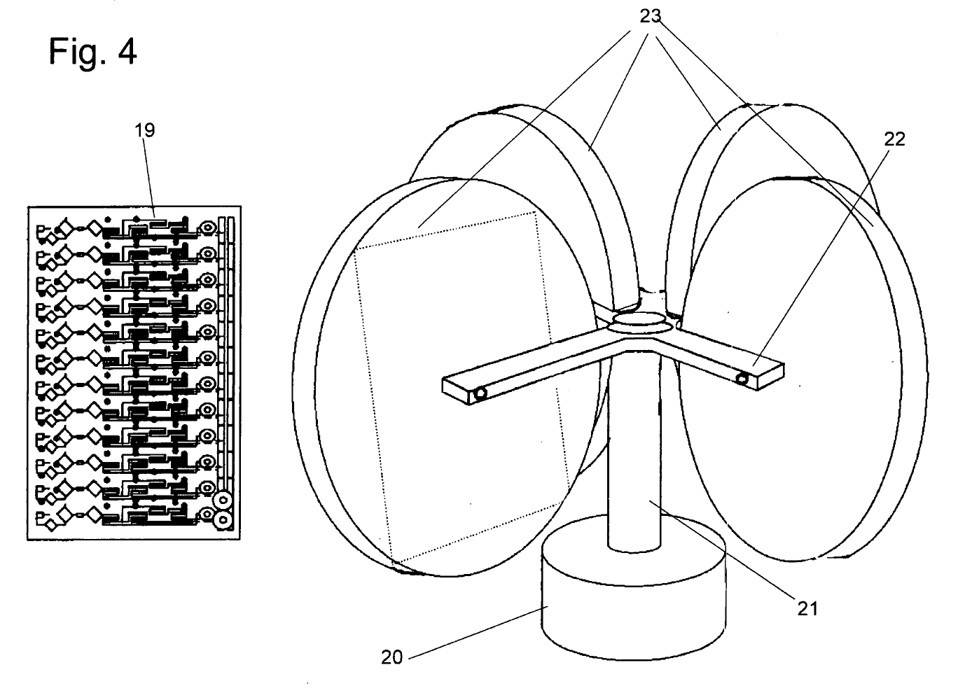

FIG. 4 depicts an open channel microfluidic platform and its associated centrifuge unit designed to perform parallel processing operations on a large number of different samples. Microfluidic platform 19, whose operation is more fully described below, is constructed in the shape and size of a common microplate for compatibility with standard liquid handling equipment. The centrifuge unit includes a motor 20 connected to drive shaft 21. The rotor 22 connected to drive shaft 21 is a series of arms extending radially outward from the rotor's axis of rotation to pivot trunnions or bearings at the center of each attached carrier 23. Carrier 23 includes means to receive a microfluidic platform in a fixed orientation and clamping means (not shown) to hold the platform in place during the operating cycle. Microfluidic devices contained by the rotor are oriented in a vertical plane parallel to and extending outward from the rotor's axis of rotation. Each carrier 23 can be rotated vertically about its own axis when the rotor is at rest to position the microfluidic platform in any specified orientation in the plane relative to the direction of centrifugal force when the rotor is turning. Rotation of the platform holding carriers on their own axis can be accomplished by a second motor (not shown) that first engages a ratchet mechanism, gear box or other such mechanism known in the art to rotate the carriers independently or simultaneously to the desired position when the rotor is at rest, then disengages from the rotor mechanism prior to the reapplication of centrifugal force.

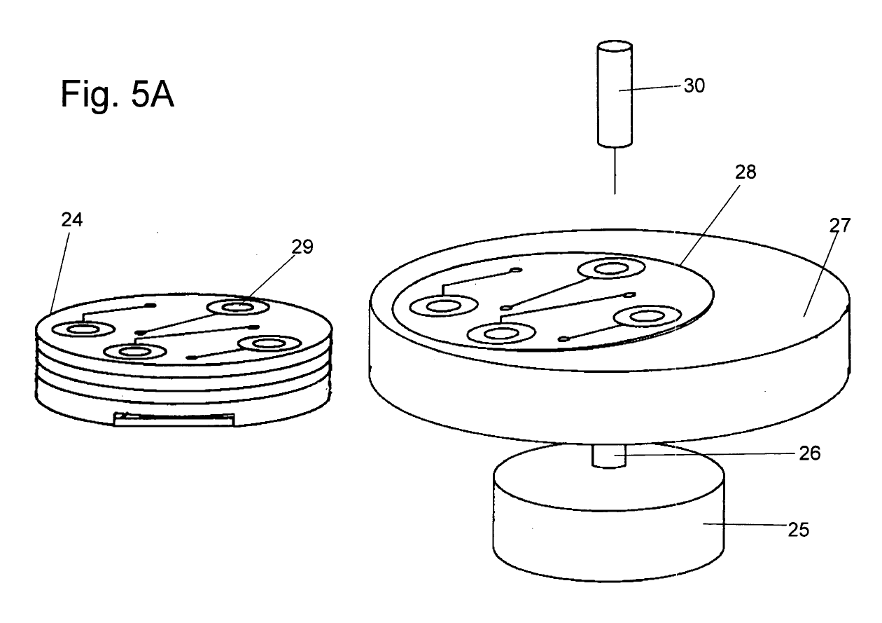

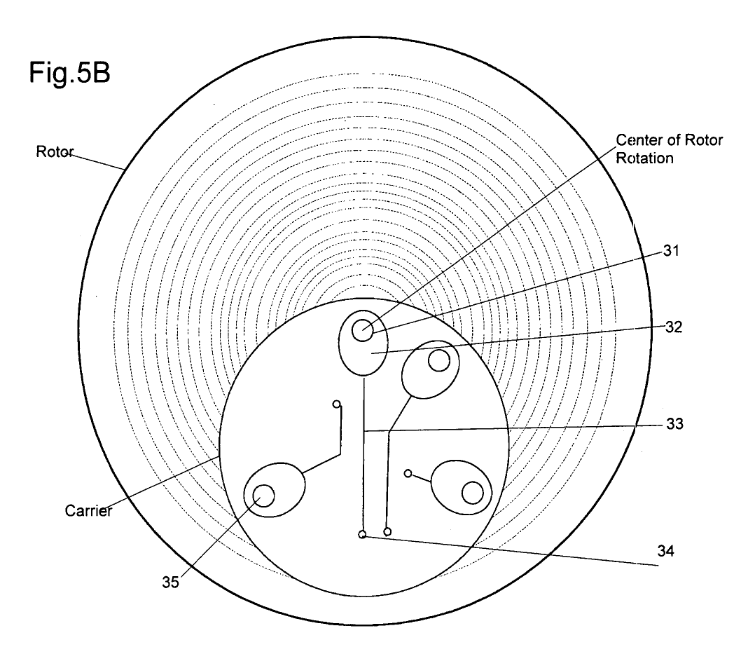

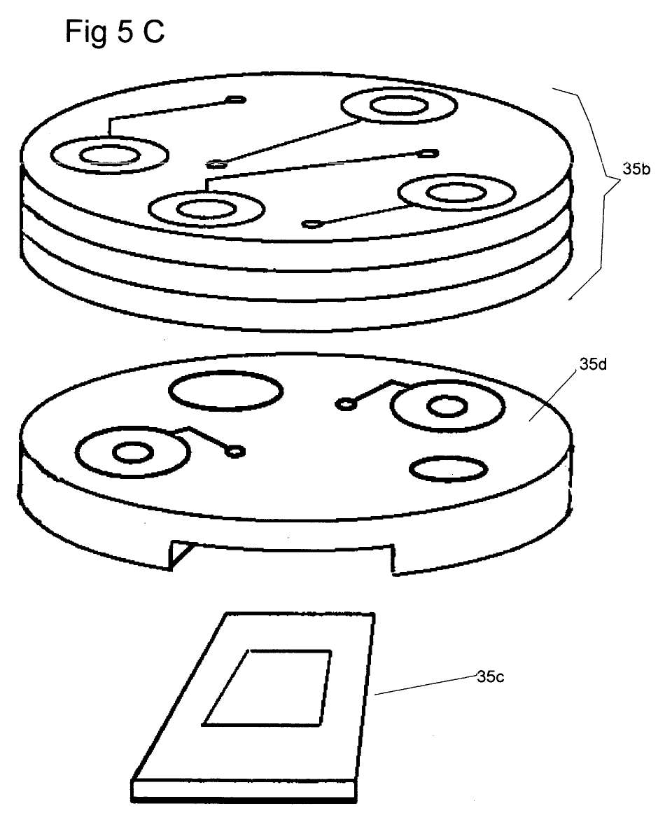

A rotor of the type illustrated in FIG. 4 can include any practical number of carriers to process hundreds of individual samples in microfluidic platforms of the type depicted. FIG. 5A shows another embodiment of the invention in which reagents can be added in specified volumes and at specified times during the processing cycle of a microfluidic platform 24. In this iteration of the centrifuge unit, motor 25 and drive shaft 26 are connected to rotor 27, a circular plate in a horizontal plane positioned at a right angle to the rotor's axis of rotation. Rotor 27 has a single carrier 28 that includes means to receive a microfluidic platform in a fixed orientation and clamping means (not shown) to hold the platform in place during the operating cycle. The circular carrier 28 extends over the center of rotation of the rotor such that when the rotor is turning, a fixed point on the outer edge of the installed microfluidic platform assumes a stationary position at the rotor's axis of rotation. Carrier 28 can be rotated horizontally about its own axis when the rotor is at rest to position the installed microfluidic platform in any specified orientation in the plane relative to the direction of centrifugal force when the rotor is turning. Rotation of the platform holding carrier on its own axis can be accomplished by a second motor (not shown) that first engages a ratchet mechanism, gear box or other such mechanism known in the art to rotate the carrier to the desired position when the rotor is at rest, then disengages from the rotor mechanism prior to the reapplication of centrifugal force. The microfluidic platform 24 designed for this application includes one or more fluid receiving chambers 29 which, when positioned at the center of the rotor's rotation by orientation of the holder, can receive fluids dispensed by gravity from a syringe 30 or other liquid handling device located directly above the rotor's center of rotation. FIG. 5B is a top view of the rotor with the microfluidic platform installed in the carrier. Liquid dispensed by gravity past opening 31 of the laminate into chamber 32 of the device is forced outward radially from the rotor's center of rotation upon turning of the rotor to the chamber walls and into channel 33 and through-hole 34. Under the influence of centrifugal force, the liquid is then moved to the appropriate location within the open channel microfluidic platform to perform the intended operation. In accordance with this embodiment, liquid can be added to the device while the rotor is stopped or while it is turning. In a subsequent operation of the processing cycle, the platform can be reoriented so that chamber 35 is located at the rotor's center of rotation such that another liquid can be added to the device for distribution to a separate or adjoining pathway. If needed to compensate for rotor imbalance that occurs by adding mass to the microfluidic platform during the operating cycle, the microfluidic platform may be designed to position and hold fluids near the rotor's center of rotation to minimize the extent of imbalance, or the rotor may have a movable counterweight (not shown) connected to the platform reorientation mechanism to automatically compensate for mass added to the device during the operating cycle. Referring again to FIG. 5A, this embodiment is well suited to perform complex multi-step procedures which may involve addition of various reagents and other liquids in the course of the processing scheme.

The device illustrated in FIG. 5C is a hypothetical platform designed to perform sample preparation, hybridization and other steps involved in the processing of commercial microarray slides. The device has various layered components 35B all acting in a single plane relative to the direction of centrifugal force. The layers, not shown in detail, may include provision to mount a microscope slide containing a microarray 35C to a shallow chamber preferably on the underside of a reusable or disposable component 35D. Once components 35B and 35D are assembled and microarray slide 35C is clamped to the underside of the device, and the device with microscope slide is placed in an automatic centrifuge unit of the type depicted in FIG. 5A, a variety of procedures designed to purify, amplify, enrich or otherwise prepare a sample, condition the microarray slide and hybridize purified components of the sample to targets on the microarray slide can be automatically carried out. The reorientation of the device relative to the direction of centrifugal force may be advantageously applied to enhance turbulence within the microarray chamber which is known in the art to shorten the time required for hybridization. Heaters, coolers and other such mechanisms required in the process may be included as part of the microfluidics platform or the centrifuge chamber (not shown) may be equipped with temperature and humidity control systems to control the environment in which the microfluidic device is processed.

FIG. 6 illustrates a planar microfluidic device seen from the top in plan view. The illustrated device is configured to carry out an immunoassay on blood when placed in a centrifuge unit of the type depicted in FIG. 3. The components of the device are as follows: A sample entry port 36 which is formed as a hole in the laminate material through which an anticoagulated blood sample to be tested is introduced into sample chamber 37. During operation when the device is in a particular orientation with respect to the direction of centrifugal force, sample in excess of 50 μL is delivered to waste chamber 38 through overflow channel 39. Hole 40 is cut into the laminate to provide venting for waste chamber 38. Sample chamber 37 is fluidly connected to separating chamber 41 by channel 42 such that when the device is oriented in a proper position relative to the direction of centrifugal force, the 50 μL of blood contained in sample chamber 37 is transferred to separating chamber 41, thereby forming a column of blood whose upper surface within separating chamber 37 is at a position directly below the opening to plasma outlet channel 43. The application of centrifugal force causes cells of the blood to concentrate at the base of the chamber leaving plasma at the top of the fluid column. The “V” shaped perturbation within separating chamber 41 is designed to shorten the length of the red blood cell/plasma interface of the separated blood in order to minimize possible re-suspension of cells upon stopping of the centrifuge and reorientation of the device. Holding chamber 45 is designed to receive at least 10 μL of plasma from the upper level of the separated blood contained in chamber 41, through plasma outlet channel 43 when the device is placed in a particular orientation relative to the direction of centrifugal force. Measuring chamber 46 has a fill capacity of 7 μL and may contain (illustrated as waved lines) reagent such as a specific binding species, for example an antibody or antibody fragment, preferably immobilized within the measuring chamber, more preferably surface bound in the measuring chamber. When the device is positioned in a particular orientation relative to the direction of centrifugal force, measuring chamber 46 receives through channel 47, in sequential cycles of the operation of the device, plasma, wash buffer and chromogen fluid which had been contained in holding chamber 45. Upon filling of the measuring chamber during a cycle, excess plasma, wash buffer or chromogen fluid is directed to vented waste chamber 49 through overflow channel 48. Vented chamber 50, connected to measuring chamber 46 by channel 51, provides added venting to prevent air pockets or bubbles from being trapped in the measuring chamber. The shape of measuring chamber 46 as well as its location on the platform allows contents of the measuring chamber to be emptied through channel 48 to vented waste chamber 49 when the device is placed in another specific orientation relative to the direction of centrifugal force. At the beginning of the test sequence, immediately before or after introduction of the blood sample, an undetermined volume greater than 30 μL of suitable wash buffer is introduced to the device at wash buffer inlet port 52 into wash buffer chamber 53. During the first sequence of operation when the device is in a particular orientation with respect to the direction of centrifugal force, wash buffer in excess of 15 μL is delivered to diluent chamber 54 through overflow channel 55. At this same orientation of the device and during the same operating cycle, wash buffer in excess of 15 μL overflows diluent chamber 54 through overflow channel 56 to vented waste chamber 38. At the completion of the first cycle of operation, wash buffer chamber 53 and diluent chamber 54 both contain 15 μL of fluid.

In a subsequent operating cycle of the device wherein the device is positioned at a specific orientation relative to the direction of centrifugal force, fluid contained in wash buffer chamber 53 passes through wash buffer outlet channel 57 to holding chamber 45. In a series of steps accomplished by the stopping of the centrifuge, the reorientation of the device to a specific position relative to the rotor's center of rotation, and the starting of the centrifuge, the wash buffer is passed through measuring chamber 46 to waste chamber 49 in order to remove unbound material remaining from the earlier passage of plasma through the measuring chamber. During one operating step, channel 58 provides a path for the column of blood, from which test plasma has been previously extracted, to pass into vented waste chamber 59 wherein the blood is sequestered during subsequent operating steps to avoid possible contamination of the test reagents or test surfaces. Chromogen chamber 60 contains a powdered tests reagent (illustrated as dots) such as an antibody detection agent, fluorescent dye, chromaphor or other agent for detection of specific binding. In an operating cycle of the device wherein the device is positioned at a specific orientation relative to the direction of centrifugal force, the 15 μL of buffer contained in diluent chamber 54 is released through channel 61 to chromogen chamber 60 in order to reconstitute the powdered reagent into liquid form. Chromogen outlet channel 62 includes an “inverted u-shape” design intended to prevent passage of liquid reagent from chromogen chamber 60 during various operating sequences of the device until the device is positioned in a specific orientation relative to the direction of centrifugal force. In a series of steps accomplished by the stopping of the centrifuge, the reorientation of the device to a specific position relative to the rotor's center of rotation, and the starting of the centrifuge, the chromogen reagent is passed through chromogen outlet channel 62 to holding chamber 45, then through channel 47 to measuring chamber 46, wherein specific binding of analyte is indicated by color or fluorescence production at the binding sites on the interior surface of the chamber.

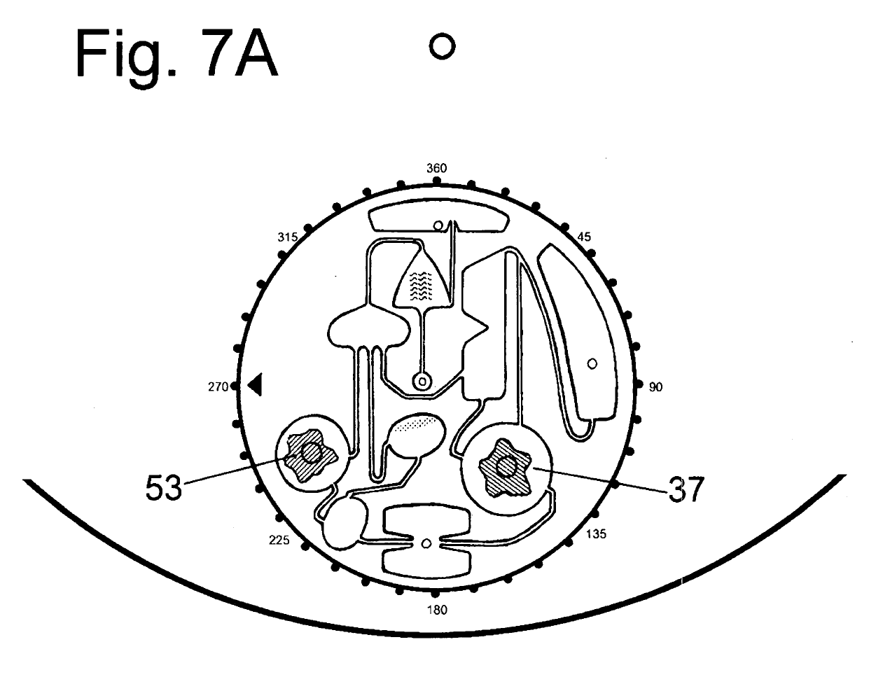

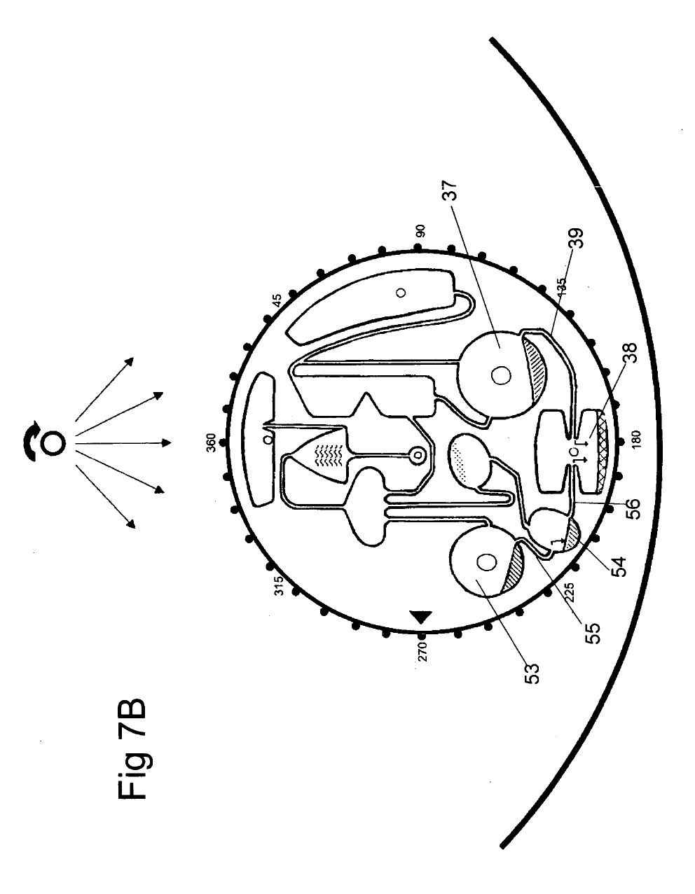

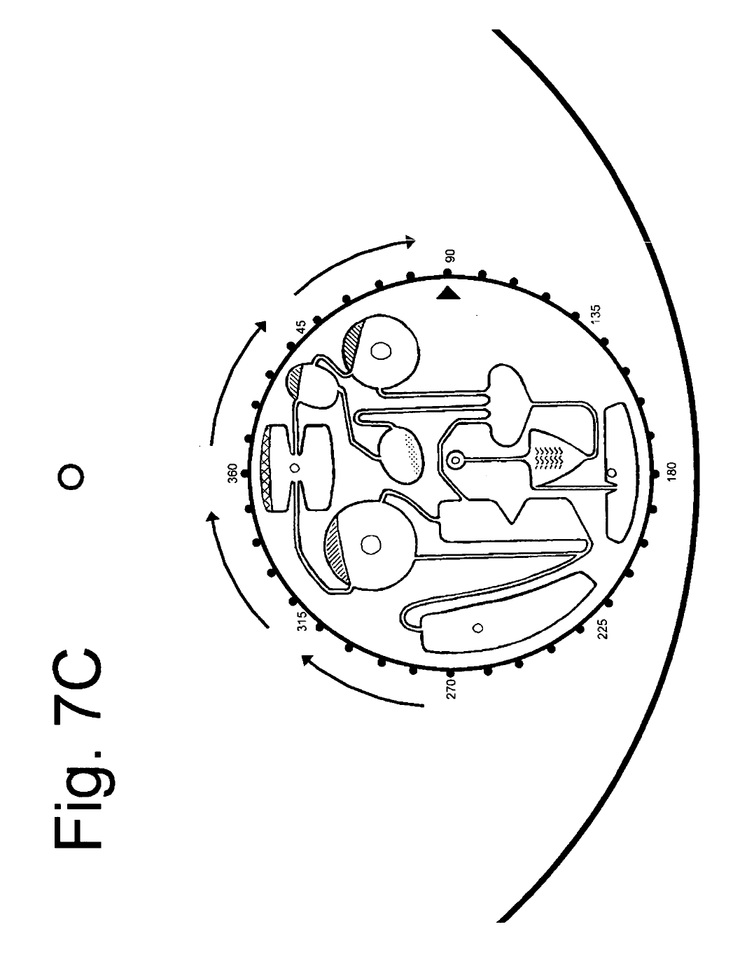

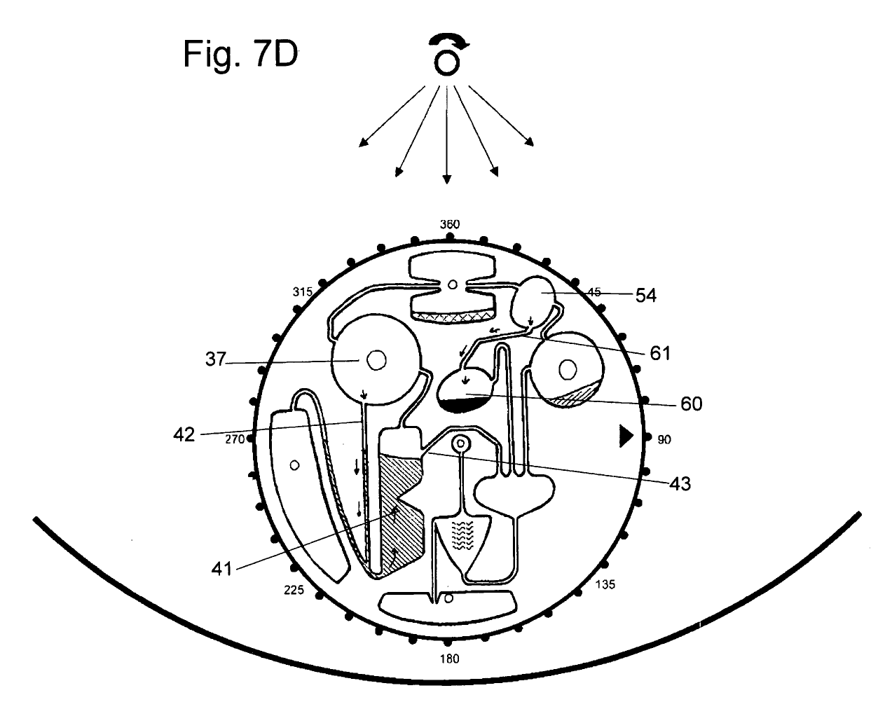

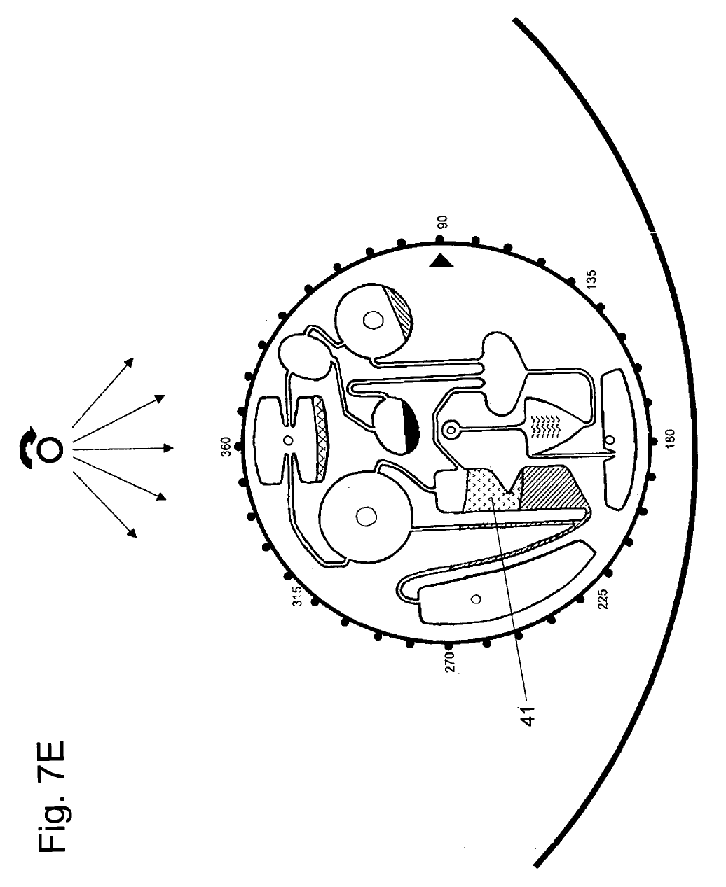

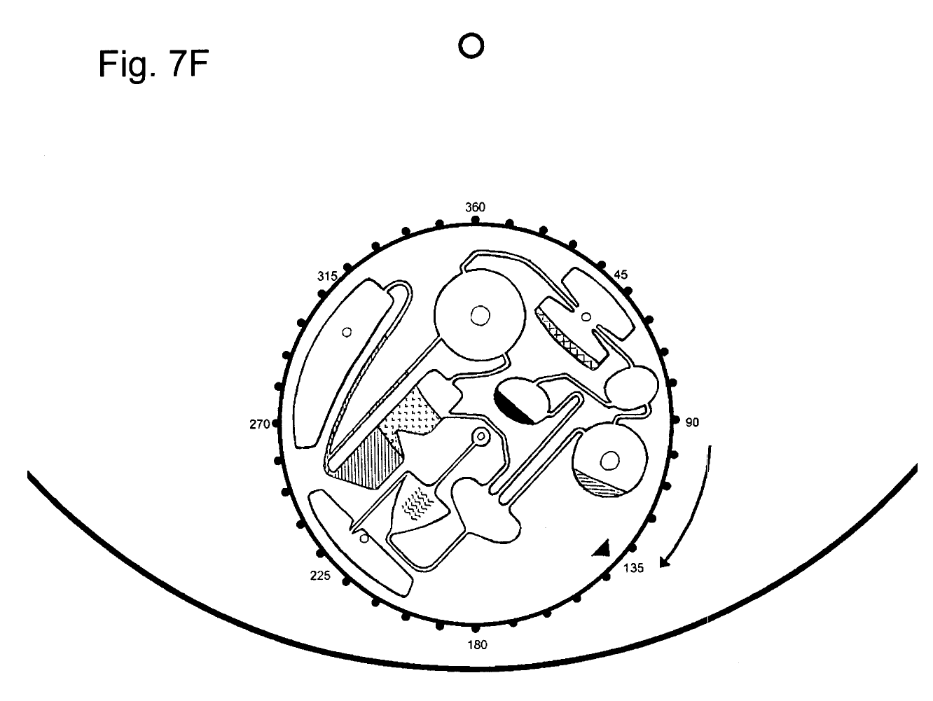

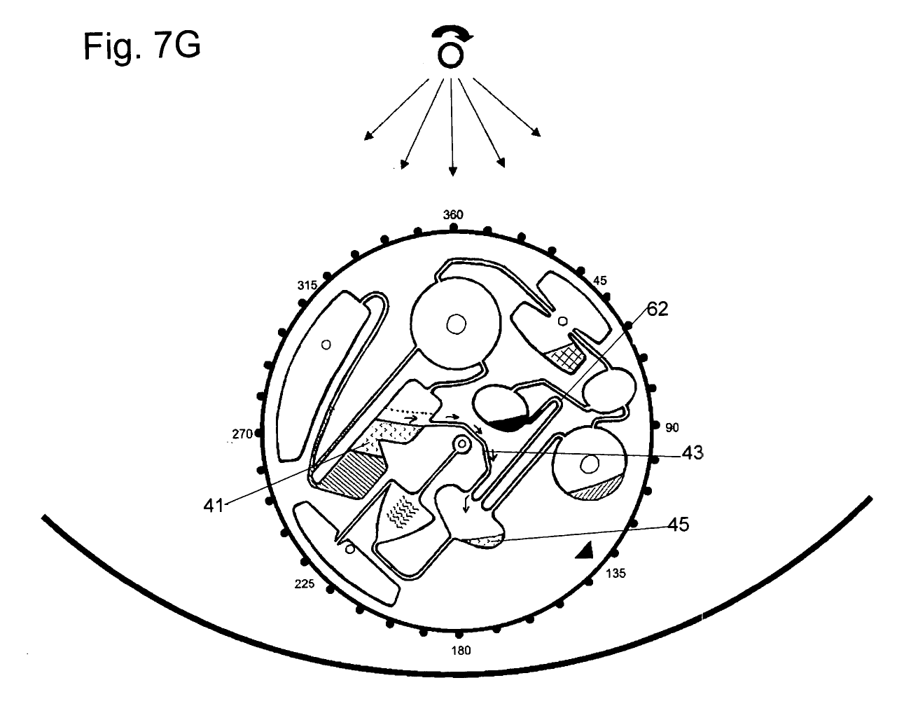

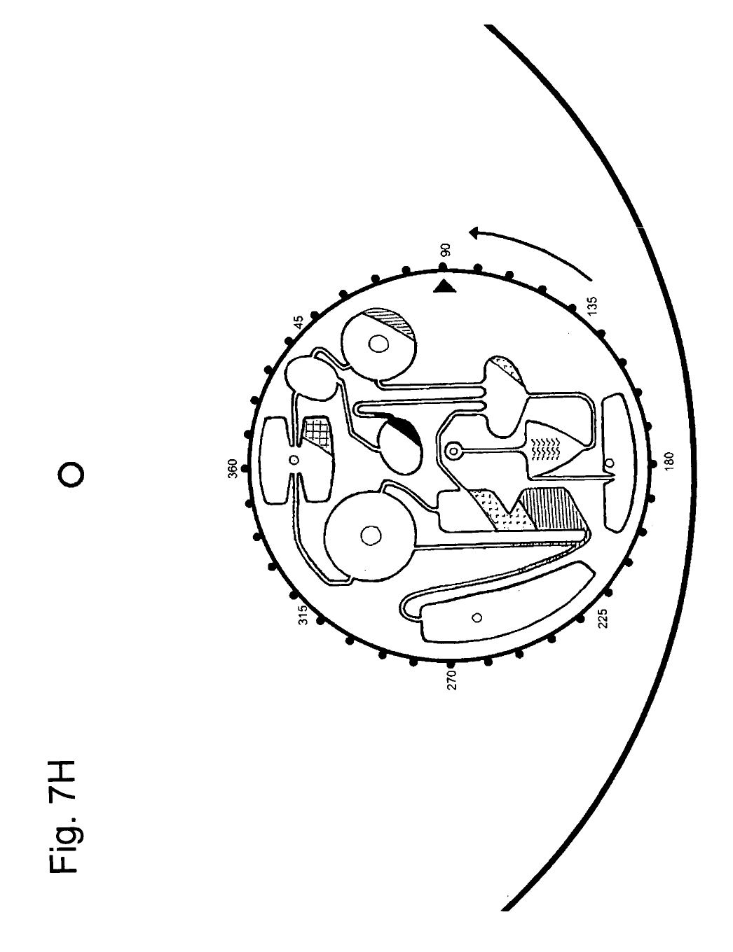

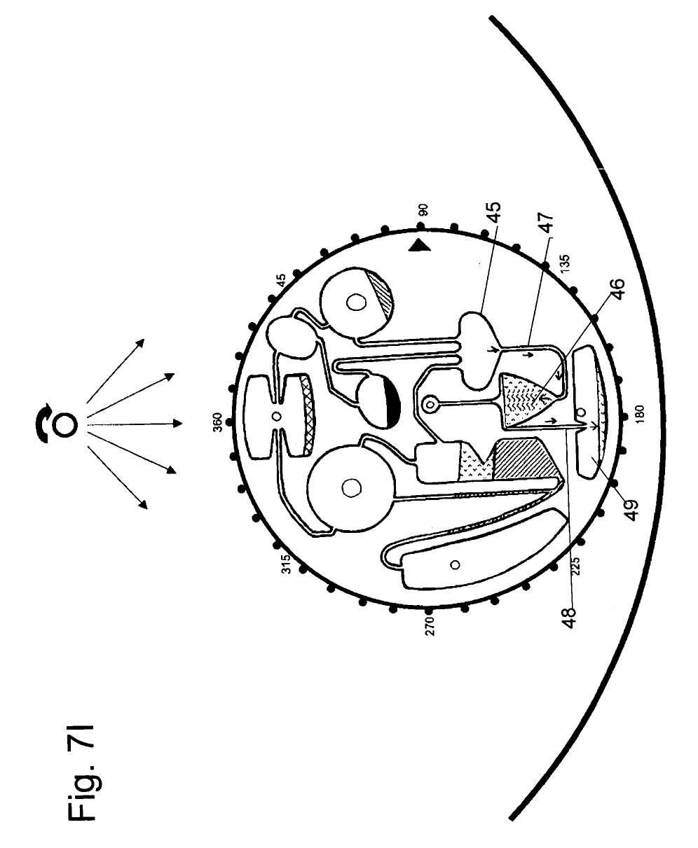

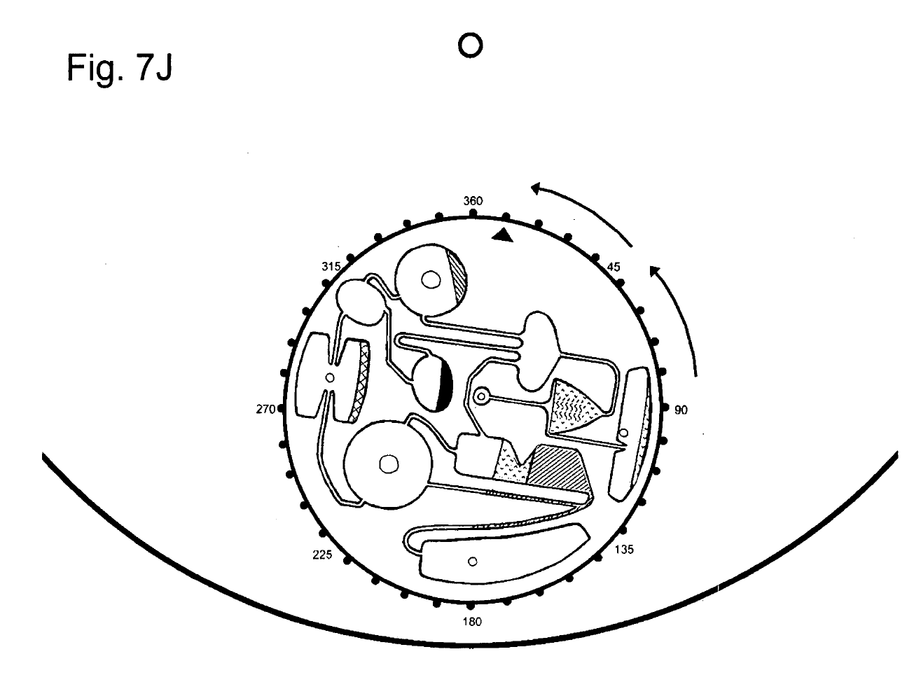

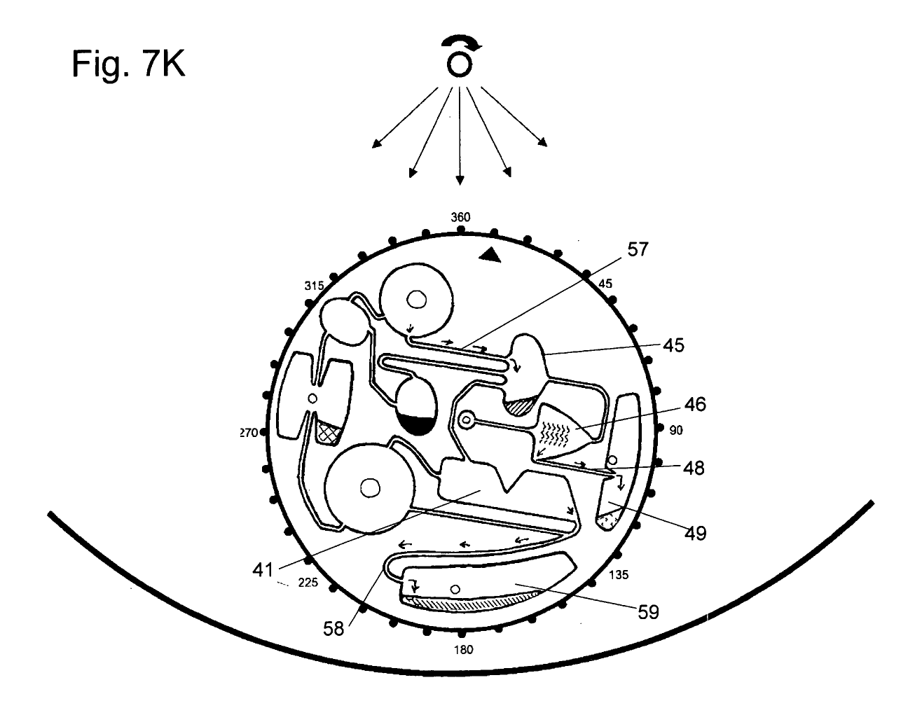

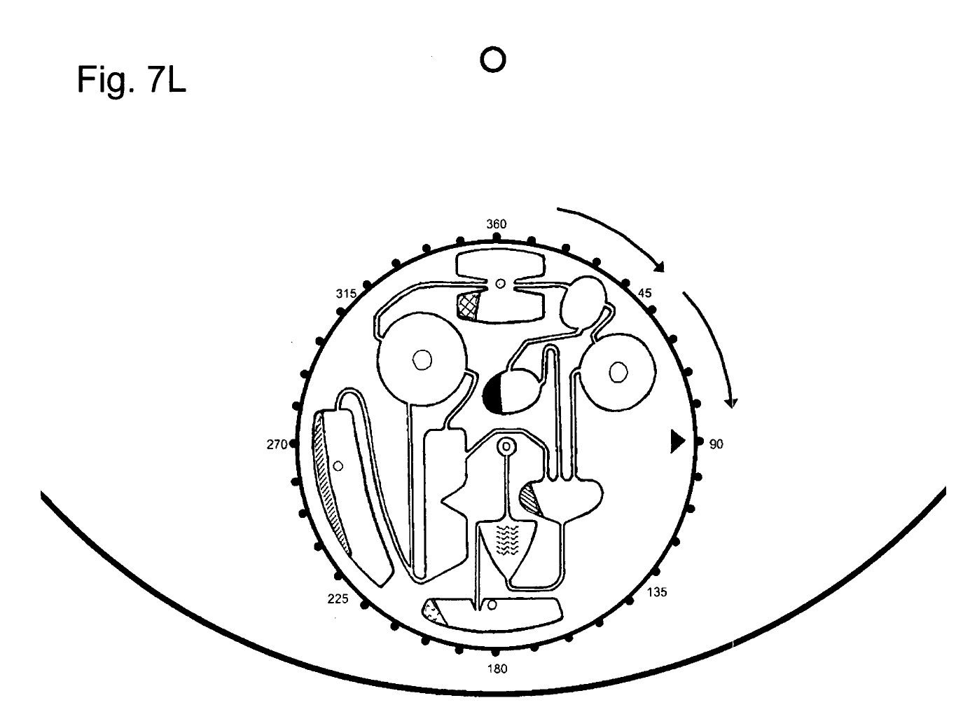

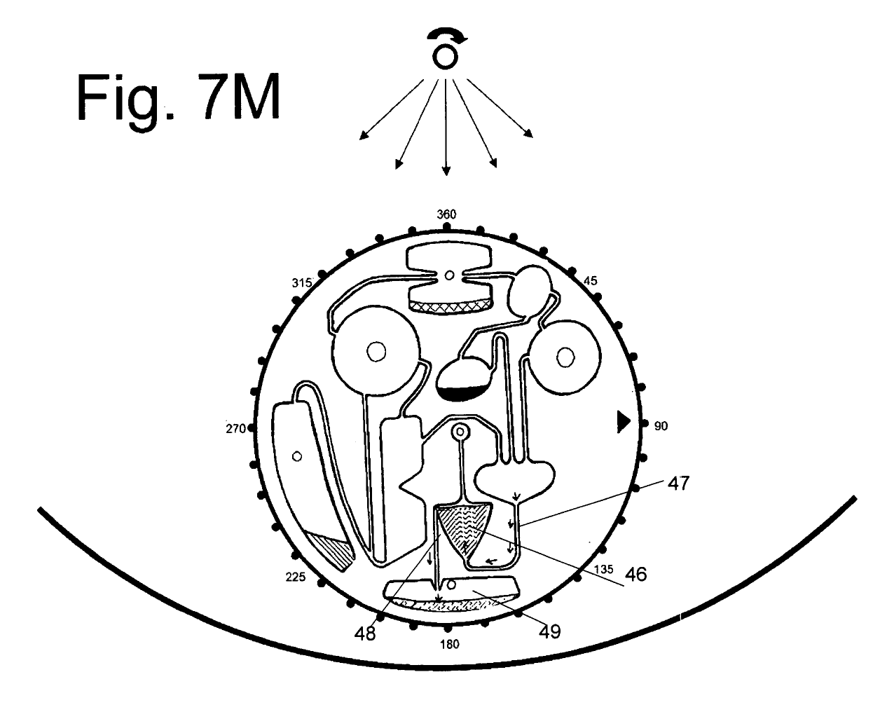

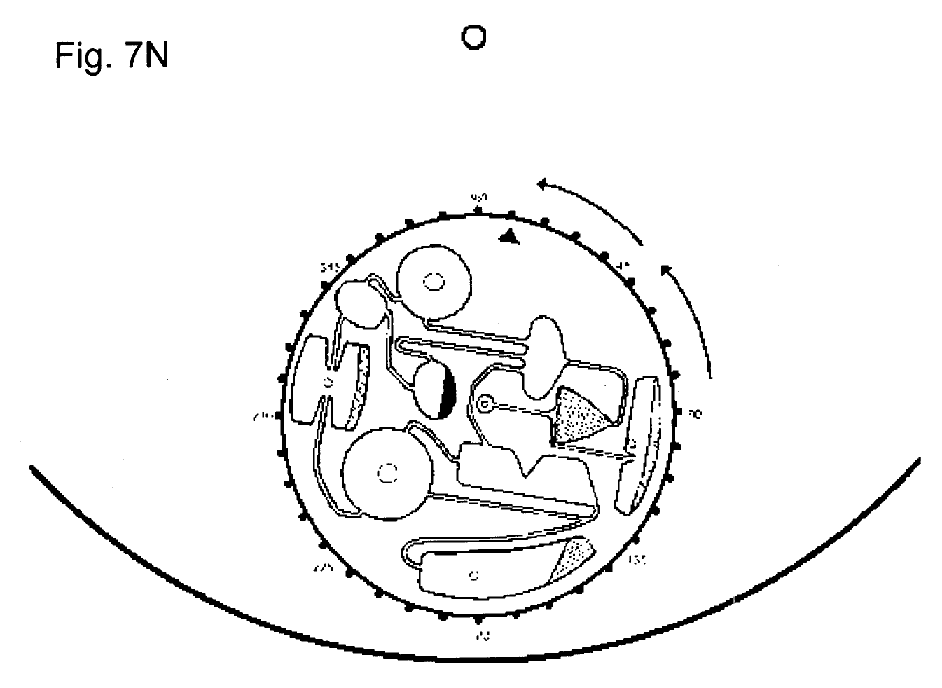

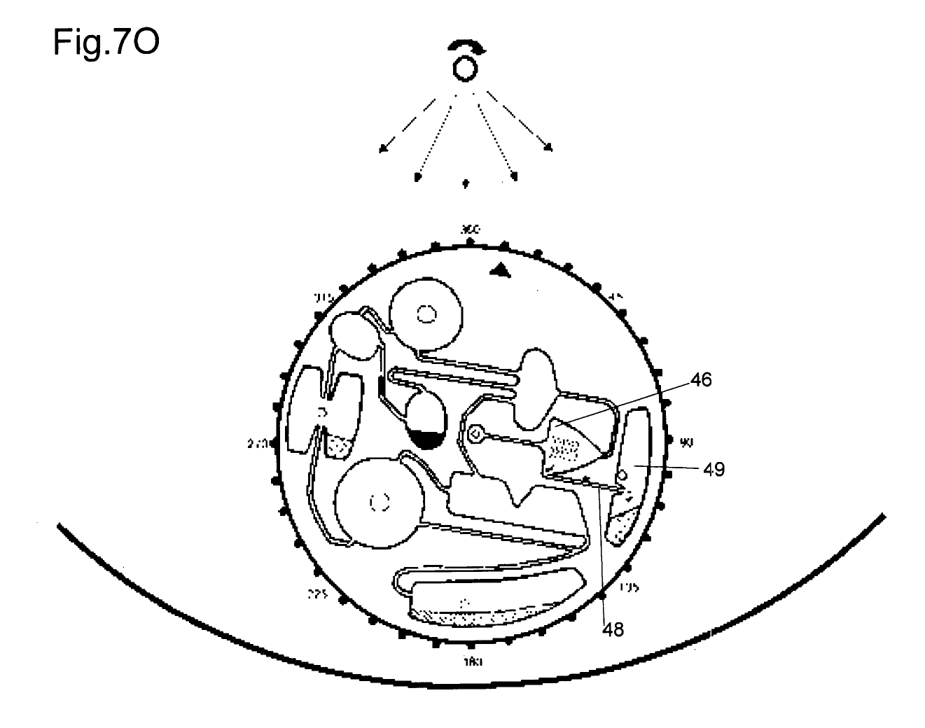

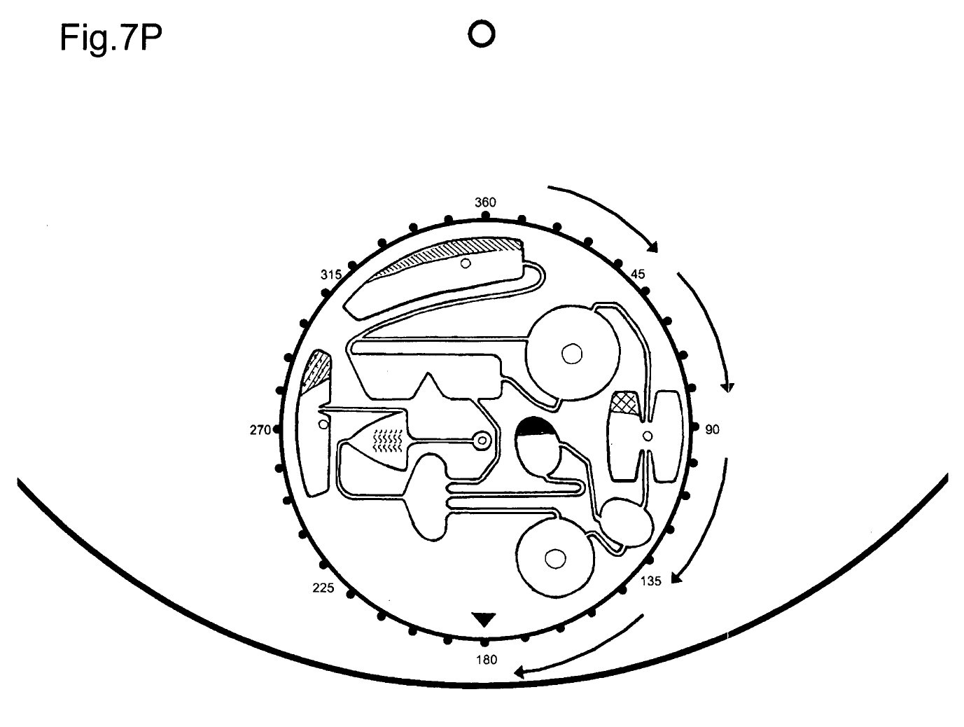

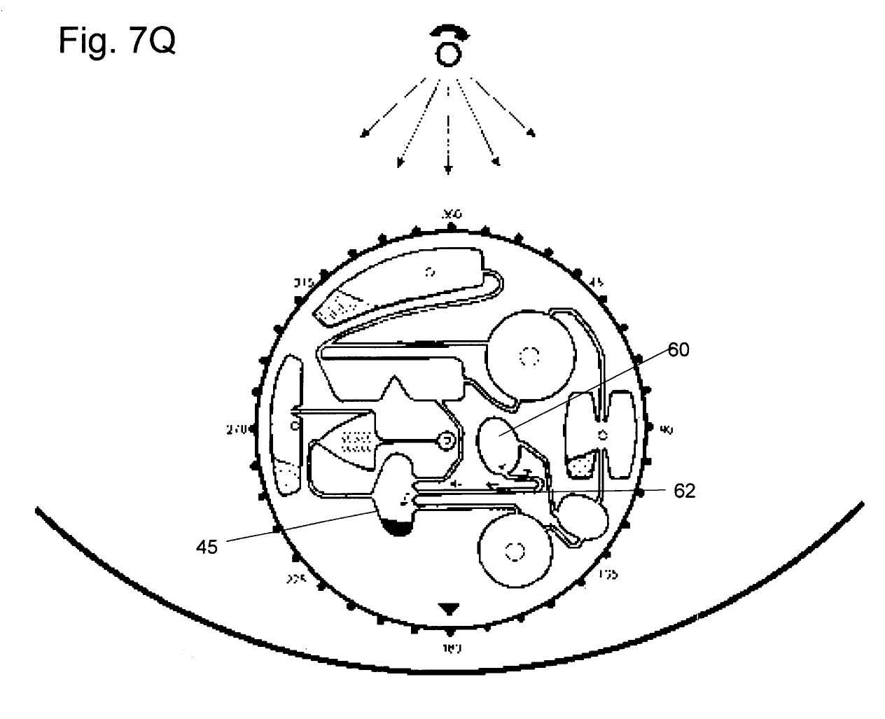

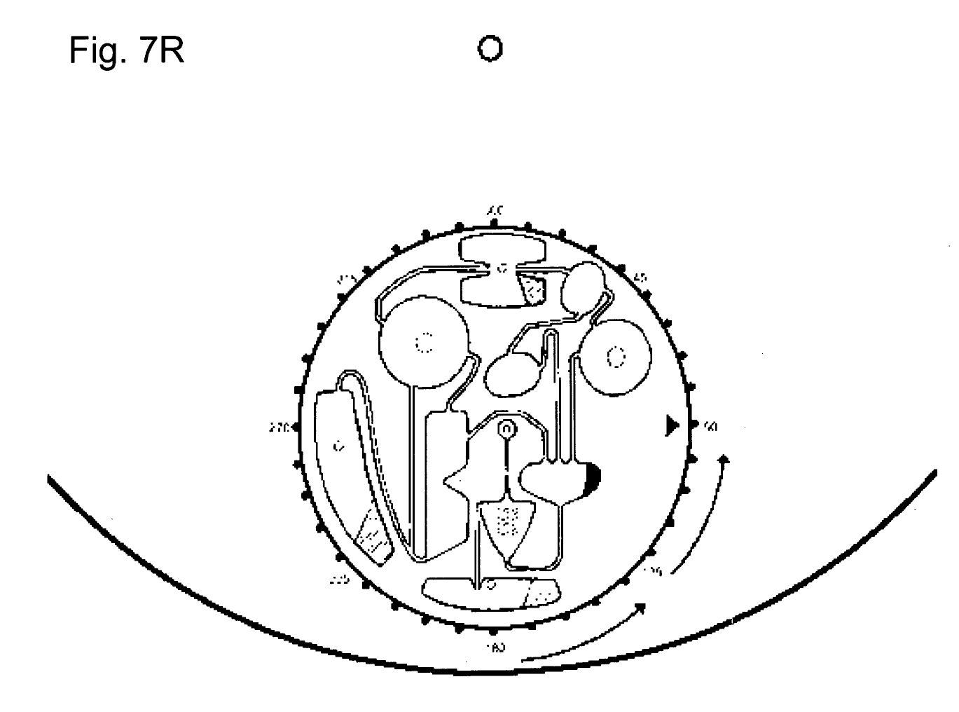

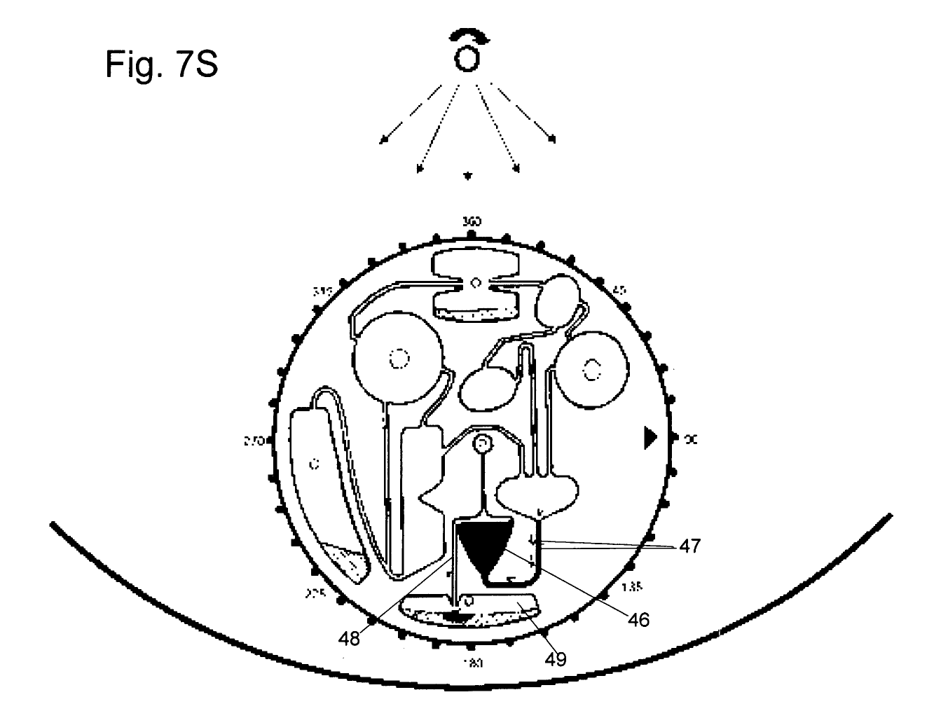

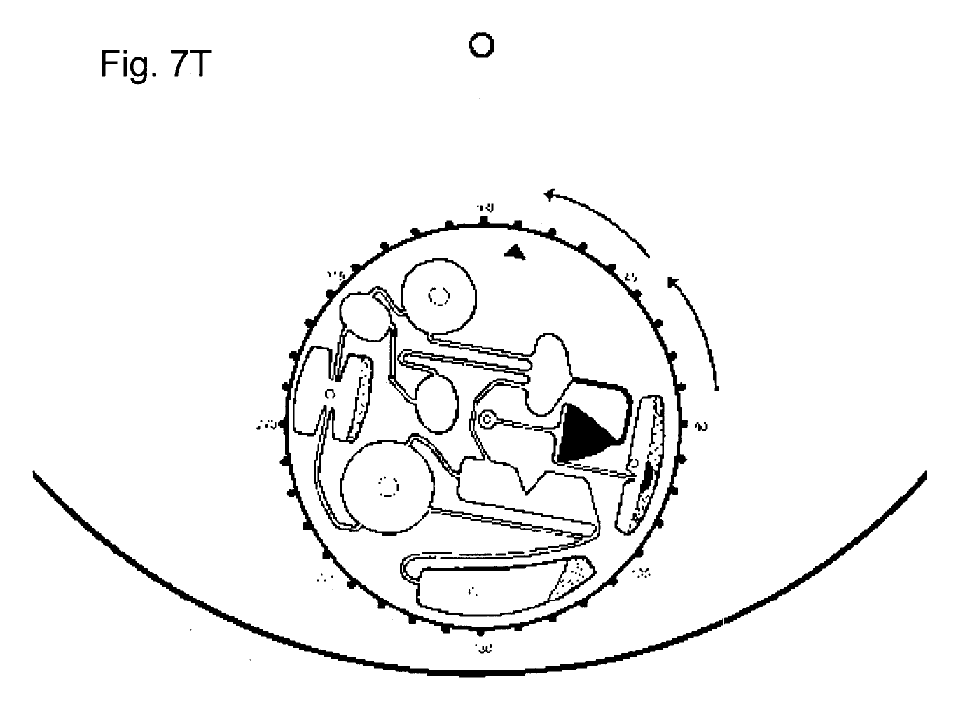

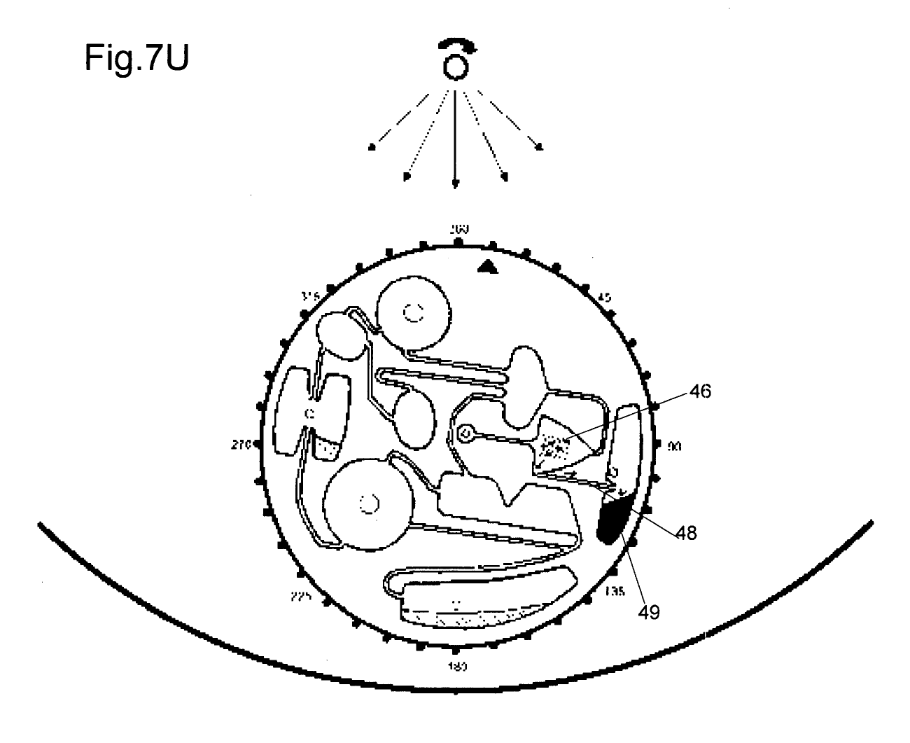

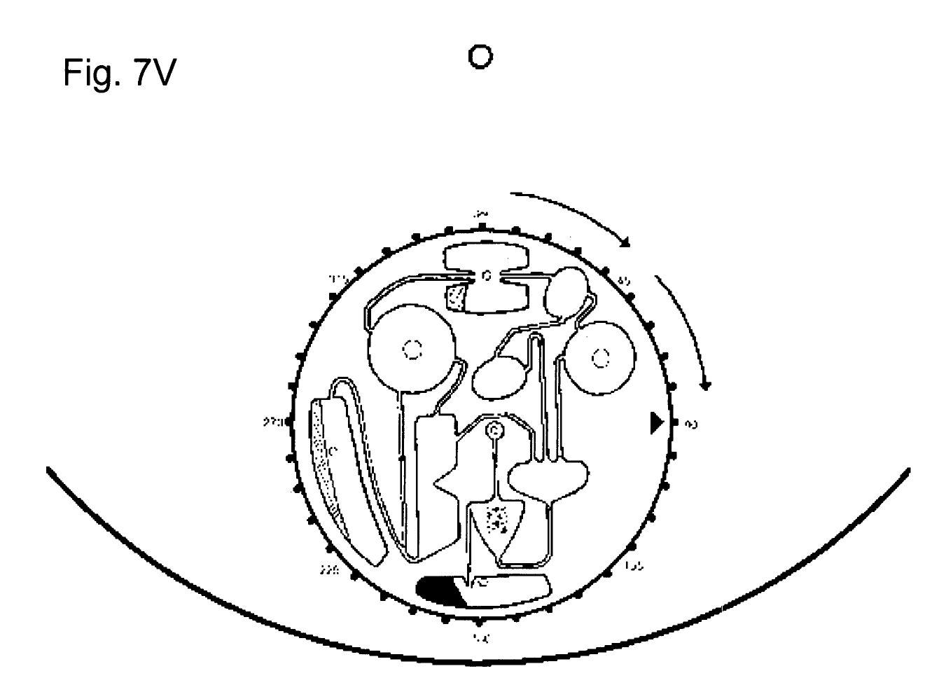

In the plan views that make up FIG. 7A-V, the microfluidic device is positioned on a rotatable platform located radially, outwardly from the rotor's center of rotation indicated by the small circle above the device illustration in each of the drawings. It should be understood that in practice a rotor may contain numerous planar platforms such as the one illustrated. In FIG. 7A the rotor is at an initial stopped position. An undetermined volume of anticoagulated whole blood greater than 50 μL is added to sample chamber 37 and an undetermined volume of buffer greater than 30 μL is added to wash buffer chamber 53. Moving to FIG. 7B, the effect is seen when the rotor is accelerated to 1000 rpm or thereabouts to accomplish the first cycle of operation, that of the volume metering of blood sample, wash buffer and diluent. Upon acceleration of the rotor, wash buffer in excess of the 15 μL retained in wash buffer chamber 53 passes through overflow channel 55 to diluent chamber 54. Diluent chamber 54 retains 15 PL of this overflow buffer and excess buffer fluid passes through overflow channel 56 to vented waste chamber 38. Simultaneously, blood in excess of the 50 μL retention capacity of sample chamber 37 passes through overflow channel 39 to vented waste chamber 38.

FIG. 7C shows the rotor stopped and the position of the device and fluid contained in the device after the platform is rotated +180° on its own axis. Upon acceleration of the rotor to a speed of 2000 rpm or thereabouts as illustrated in FIG. 7D, the 50 μL of blood passes from sample chamber 37 through channel 42 to the base of separation chamber 41 and filling the separation chamber to a level directly below the opening of the plasma outlet channel 43. At the same time, the 15 μL of buffer which was previously retained in diluent chamber 54 passes through channel 61 to chromagen chamber 60 where the buffer mixes with the powdered reagent contained within the chamber in order to produce a liquid reagent to be used in the test. After a period of time, the condition in FIG. 7E is obtained wherein the cells are separated leaving plasma at the top of the column of blood in separation chamber 41; while the measured amounts of chromaphor reagent and wash buffer remain at a steady state within their chambers.

In FIG. 7F, the rotor is stopped and the platform is rotated 45° in the direction shown. FIG. 7G shows the change after the rotor is slowly accelerated to 1000 rpm or thereabouts. Slow acceleration is used to help prevent remixing of blood upon acceleration of the rotor. Fluid in the three chambers slowly reorient relative to the new direction of centrifugal force. The upper surface of the plasma momentarily assumes a position indicated by the dotted line shown in separating chamber 41 until sufficient hydrostatic pressure is achieved by the application of centrifugal force to push a portion of the blood plasma through plasma outlet channel 43 to holding chamber 45. Unwanted flow of the chromaphor reagent during this cycle is prevented by the shape, location and hyrophobicity of chromaphor outlet channel 62. Following the movement of plasma to the holding chamber, the rotor is stopped and the platform is rotated −45° to the position indicated in FIG. 7H. In FIG. 71 the rotor is accelerated to 1000 rpm or thereabouts to move plasma from holding chamber 45 through channel 47 to measuring chamber 46 where analyte of interest in the plasma is bound to antibody contained within or surface bound to the measuring chamber. Plasma in excess of the 7 μL capacity of the measuring chamber passed through overflow channel 48 to vented waste chamber 49. FIG. 7J shows the position of the device and fluid contain therein upon stopping of the rotor and rotation of the platform −80° with respect to the prior position of the platform. Upon acceleration of the rotor to approximately 1000 rpm as depicted in FIG. 7K, three operating functions are performed: first, plasma is passed from measuring chamber 46 through overflow channel 48 to vented waste chamber 49; second, blood in separating chamber 41 from which plasma for testing was previously extracted is passed through channel 58 to vented waste chamber 59 where the blood remains sequestered during subsequent operations; and third, wash buffer is moved through wash buffer outlet channel 57 to holding chamber 45. FIG. 7L shows the condition of the device upon stopping of the rotor and rotation of the platform +80° on its own axis. As shown in FIG. 7M, the rotor is accelerated to 1000 rpm or thereabouts causing wash buffer to pass through channel 47 to measuring chamber 46. Wash buffer in excess of the 7 μL capacity of the measuring chamber passes through overflow channel 48 to vented waste chamber 49.

At the completion of this cycle, the rotor is stopped and the platform is rotated −80° on its own axis as depicted in FIG. 7N. Upon acceleration of the rotor to approximately 1000 rpm as shown in FIG. 70, wash buffer and residual unbound plasma are removed from measuring chamber 46 through overflow channel 48 to vented waste chamber 49. The rotor is again decelerated to a stop and the platform is rotated 170° in the direction shown in FIG. 7P. Upon acceleration of the rotor to approximately 1000 rpm as shown in FIG. 7Q, liquid reagent is released from chromagen chamber 60 and passes through “U-shaped” chromagen outlet channel 62 to holding chamber 45. FIG. 7R shows the next sequence of operation in which the rotor is stopped and the platform holding the device is rotated +90° with respect to its prior orientation. The rotor is accelerated to 1000 rpm or thereabouts as shown in FIG. 7S whereupon the liquid reagent is moved through channel 47 to measuring chamber 46. Excess liquid reagent passes to vented waste chamber 49 through overflow channel 48. In this operating sequence, chromaphor binds to analyte which had been previously bound to antibody contained in the measuring chamber. In FIG. 7T, the rotor is stopped and the platform is rotated 80° in the direction shown. The rotor is accelerated to approximately 1000 rpm as depicted in FIG. 7U causing the liquid reagent to pass through overflow channel 48 to vented waste chamber 49, leaving chromaphor attached to analyte binding sites contained within measuring chamber 46. The final step of the operating sequence is shown in FIG. 7V in which the rotor is stopped and the platform is rotated on its own axis such that measuring chamber is positioned under or over a detection device, not shown. The detection device such as a spectrophotometer or florescence detector is used to quantify the amount of bound analyte in the measuring chamber for the desired assay. The detector mechanism may be located within the centrifuge unit for readings in place or the microfluidic device may be removed from the rotor and transferred to an external measuring instrument.

While an assay of blood was used for illustration, the design of chambers and passages can be carried out in a similar fashion for virtually any wet chemistry process where it is desired to carry out a series of reaction steps adding reagents sequentially and washing between steps. Multiple chambers, holding chambers and shaped passages may be introduced into low cost mass produced microfluidic devices useful in a wide variety of procedures. For example the method and devices of the invention are useful in DNA analysis, immunoassays, other clinical assays, blood typing and screening high through put screening for binding agents and the like, small scale analysis of materials for hazards or biological materials. The reagent volumes will normally be a few micro-liters, far less than is required for conventional analysis. A primary advantage of the invention is the ability to produce functional sequential processing by use of shaped passages with no moving parts or electronic components required, in contrast to the superficially similar processes of the prior art wherein valves and the like are used in conjunction with multi-position centrifugal forces to carry out analysis. The open channel, valve free devices of this invention require only design of the device, preparation of the appropriate masks and the required device maybe inexpensively mass produced by conventional photolithography injection molding and the like Normally the centrifuge rotor will be operated in the range of 100 to 10,000 rpm preferably 500 to 5000 rpm, and more preferably 1000 to 2000 rpm. Alternately the centrifugal force may be specified in terms of the acceleration due to gravity g and computed from the rotor dimensions and rpm. Preferably the methods are practiced in the range of 0.01 to 10.000 g; preferably in the range of 0.1 to 1,000 g, more preferably in the range of 1 to 100 g.

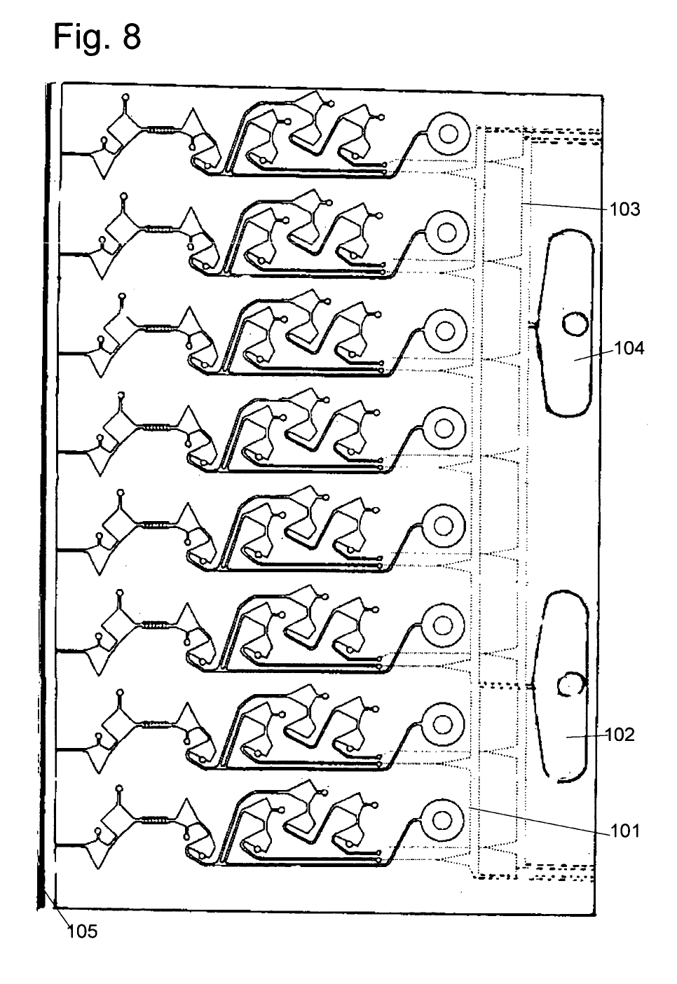

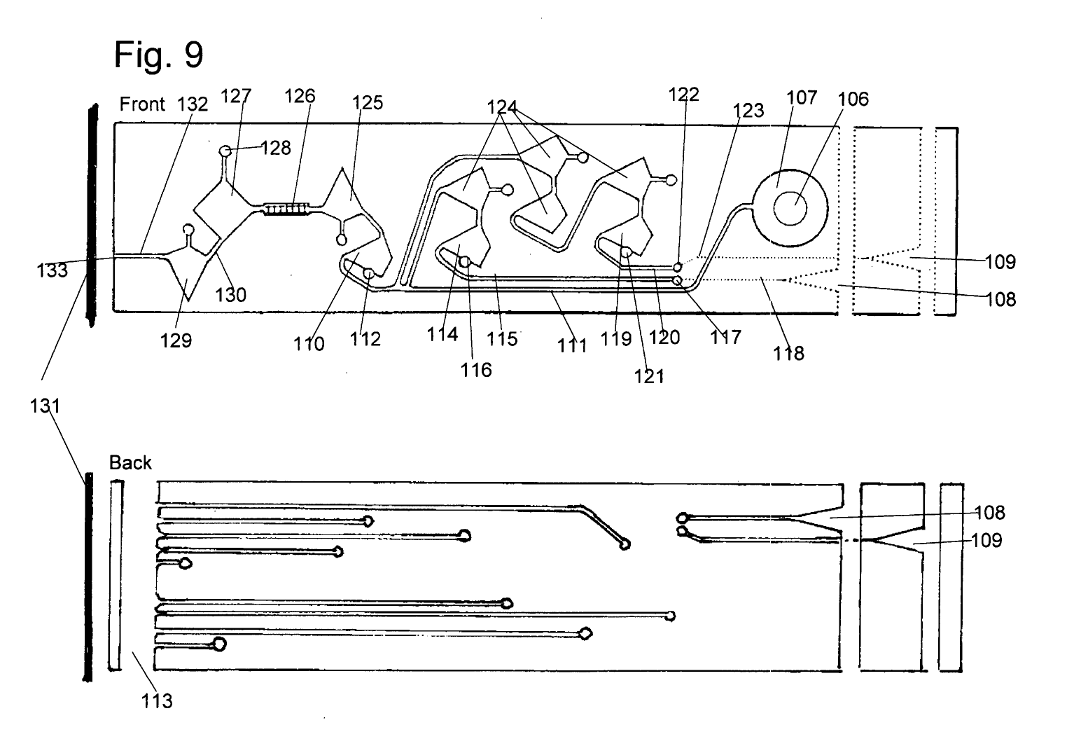

FIG. 8 is a plan view of a microfluidic device designed to perform sample preparation and other operations prior to analysis by MALDI (matrix-assisted laser desorption/ionization) mass spectrometry. When used in a centrifuge unit of the type depicted in FIG. 4, the device is intended to carry out automated micro-scale protein concentration and purification, precise mixing of analyte with matrix solution, and spotting of the analyte/matrix solution onto probes or commercial MALDI target plates. The microfluidic platform of FIG. 8 includes a series of identical microfluidic structures shown in detail in FIG. 9, each segment is connected to a common wash buffer distribution channel 101 and wash buffer reservoir 102, and to a common matrix solution distribution channel 103 and matrix solution reservoir 104. The outlet of each segment is positioned in proximity to a MALDI target plate 105 such that under the influence of centrifugal force when the device is placed in a specific orientation relative to the direction of centrifugal force, a precise volume of analyte/matrix mixture, generally in the range of 0.5 to 2.0 μL, is dispensed onto the MALDI target plate. The device shown includes eight segments positioned to correspond to a common 8×12 array 96-position MALDI target plate so that twelve of the devices could be stacked in a holder (not shown) to provide parallel processing of 96 samples. Other configurations such as for a 384 spot target plate are contemplated by the invention as well as alternative locations on the device for sample and reagent addition to allow loading of reagents and sample by automated liquid handling equipment.

FIG. 9 shows front and back plan views of one segment of the device illustrated in FIG. 8. The components of the device segment as shown on the front view are as follows: A sample entry port 106 which is formed as a hole in the laminate sealing material through which an unpurified protein digest sample is introduced into sample chamber 107. Wash buffer distribution channel 108 is connected to common wash buffer reservoir 102 in FIG. 8 to allow a sufficient quantify of wash buffer to be delivered to the segment during operation. Matrix solution distribution channel 109 is connected to common matrix solution reservoir 104 in FIG. 8 to allow a sufficient quantity of wash buffer to be delivered to the segment during operation. Chamber 110 connected to sample channel 111 includes an overflow 112 channel to define the exact volume of sample required by the specific application. All overflow channels and vents on the front view of the platform are formed as through-holes through the substrate material connecting to channels on the back surface of the substrate. The vent and overflow channels lead to a vented waste chamber 113. Chamber 114 connected to wash buffer channel 115 includes overflow channel 116 to define the exact volume of wash buffer required by the application. Wash buffer channel 115 is connected to through hole 117 which communicates with channel 118 connected to the wash buffer distribution channel located on the back of the substrate. Chamber 119 connected to matrix solution channel 120 includes overflow channel 121 to define the exact volume of matrix solution required for the application. Matrix solution channel 120 is connected to through hole 122 which communicates with channel 123 connected to matrix solution distribution channel 109 on the back side of the substrate. Vented chambers 124 service as delay chambers for wash buffer and matrix solution to allow their introduction into the test system in a sequence particular to the application. Vented holding chamber 125 provides a staging area to hold fluids prior to the purification step. Chamber 126 contains any of a variety of purification media suitable for the application including C-18 chomatography resin which is commonly used to purify and concentrate protein samples prior to MALDI mass spectrometry analysis. Distribution chamber 127 collects fluids that pass through the purification media and directs waste fluids to the waste chamber 113 through waste channel 128 when the device is placed in one orientation with respect to the direction of centrifugal force, and deliver matrix/analyte solution toward the device outlet when the device is placed in a second orientation relative to the direction of centrifugal force. Vented holding chamber 129 accepts analyte/matrix solution from chamber 127 through channel 130 and holds the solution prior to spotting of the analyte matrix solution onto MALDI target plate 131 through channel 132 and outlet 133.

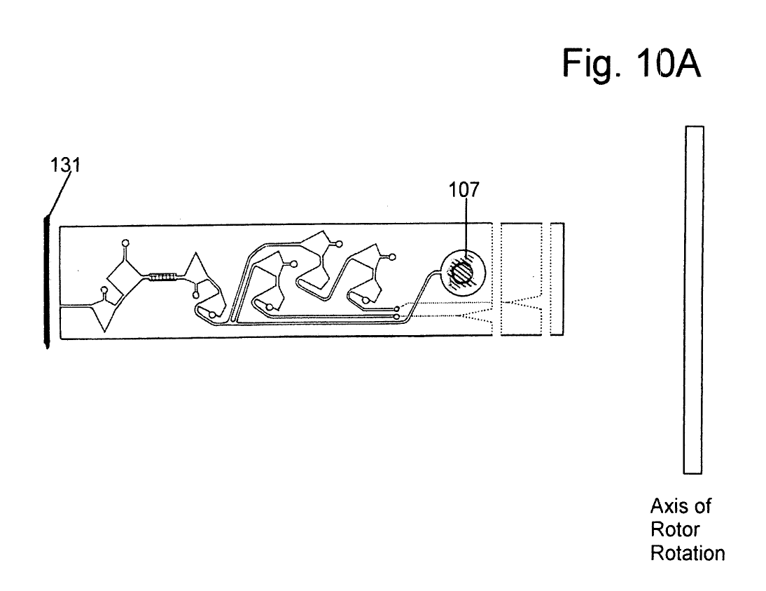

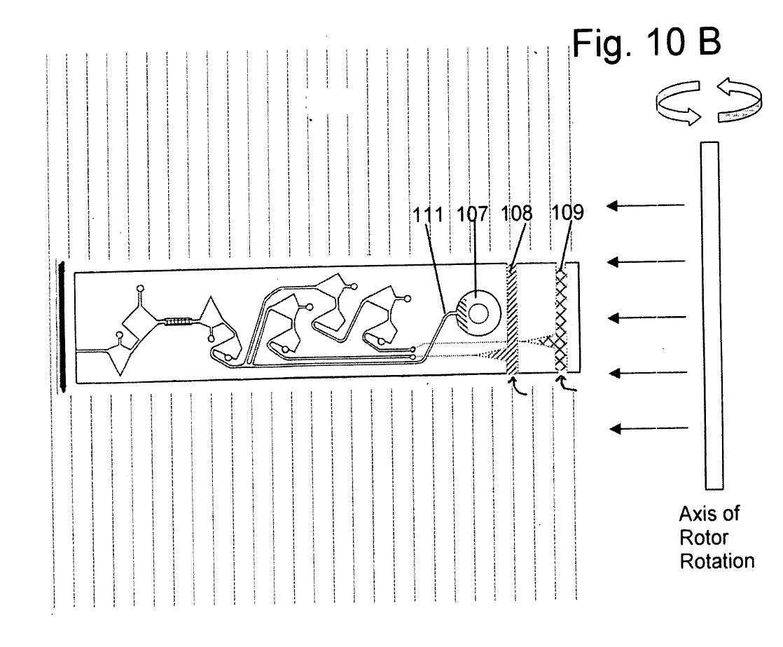

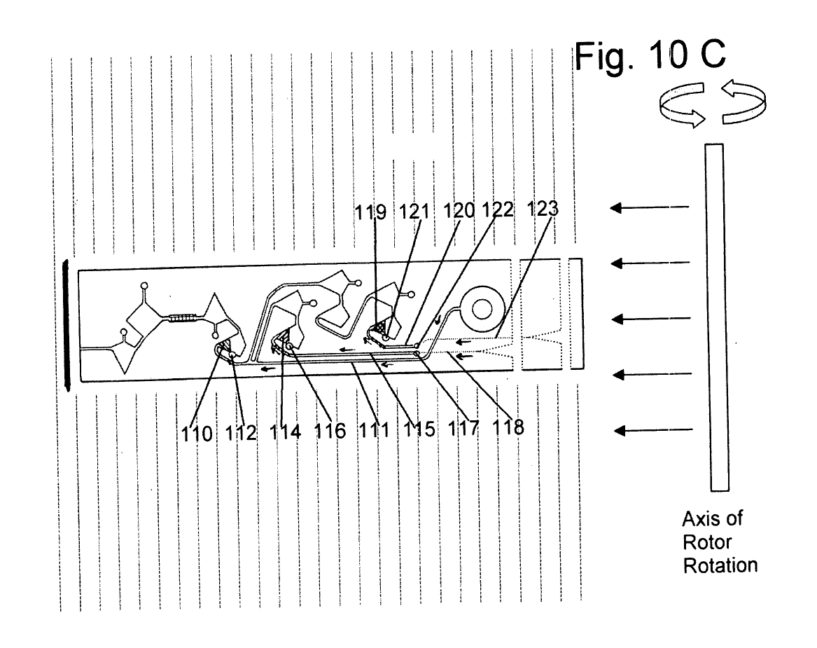

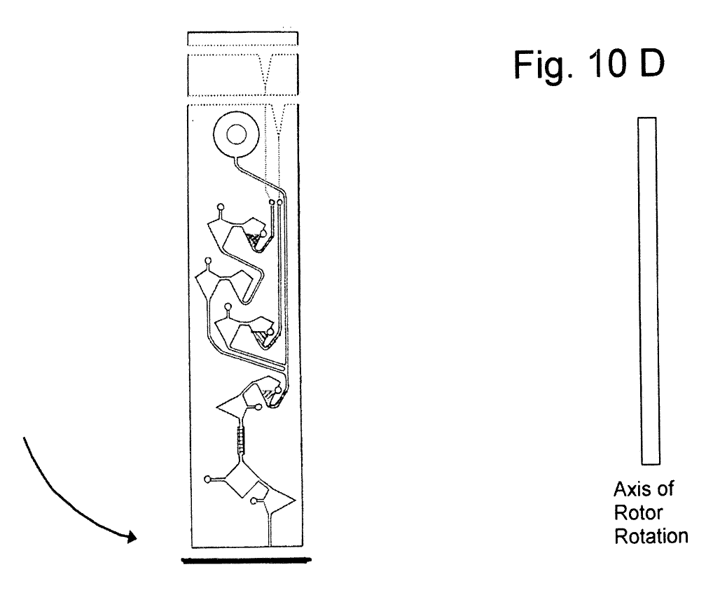

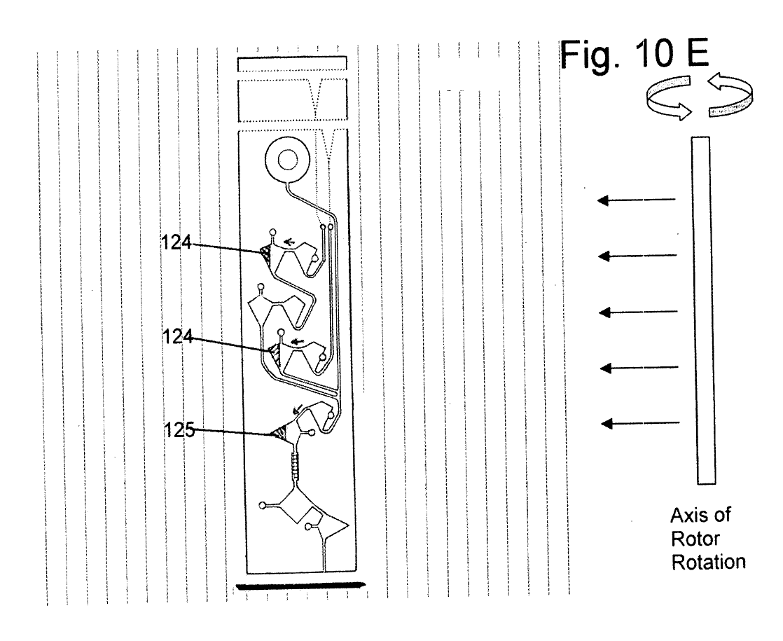

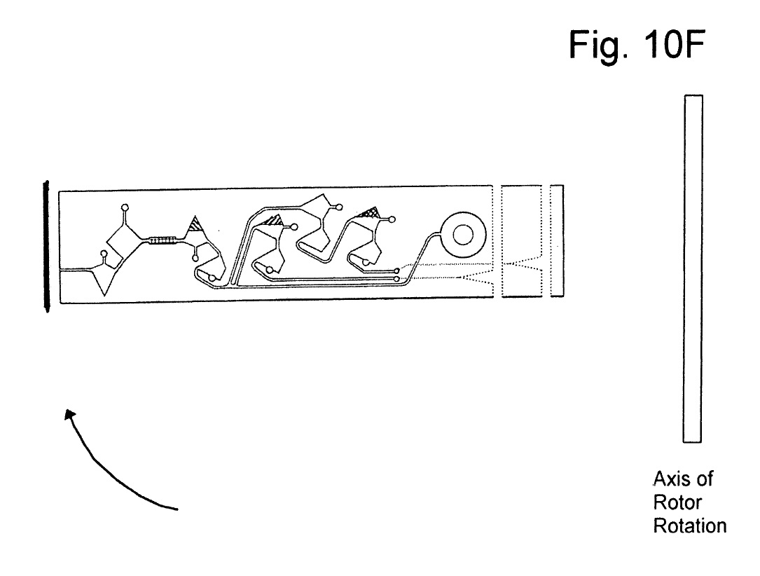

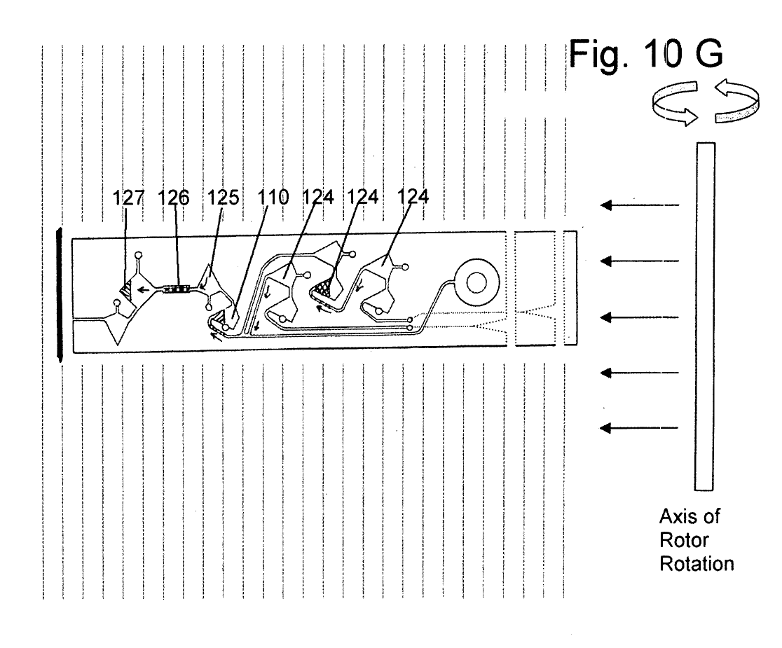

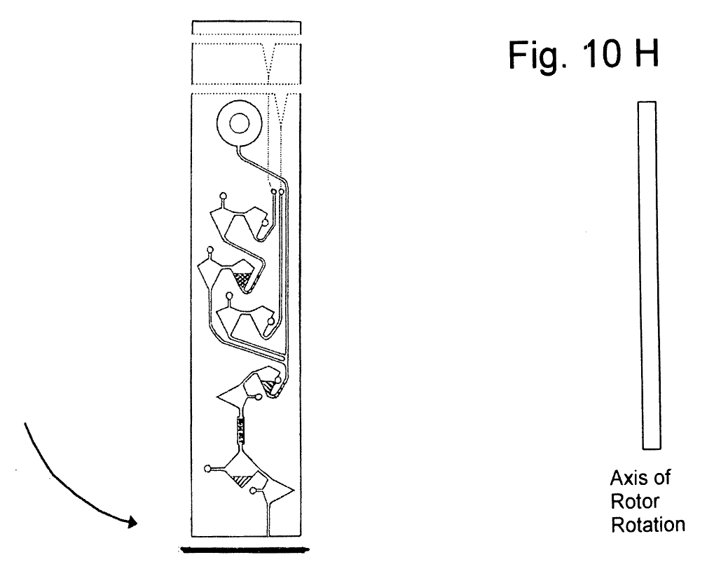

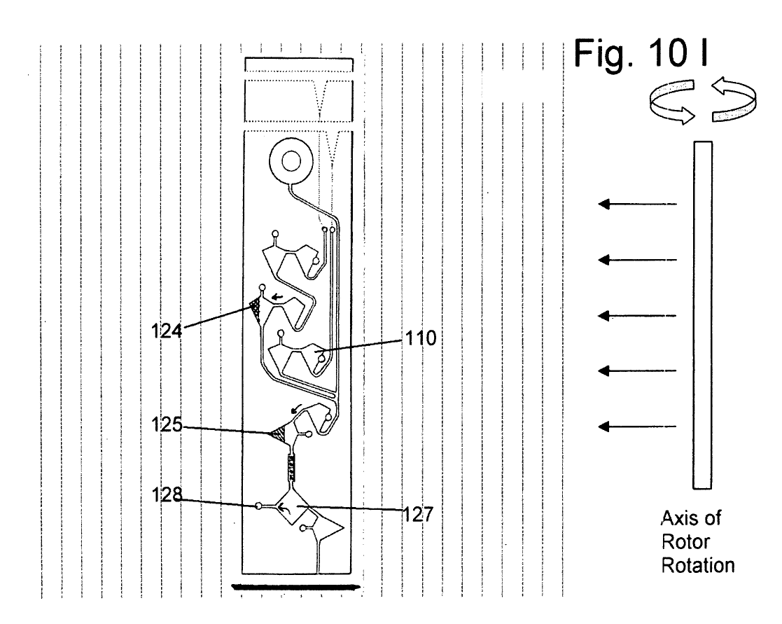

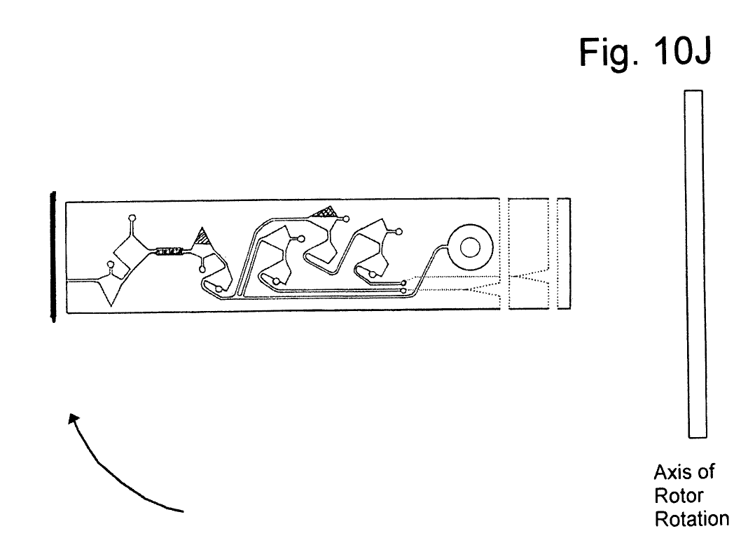

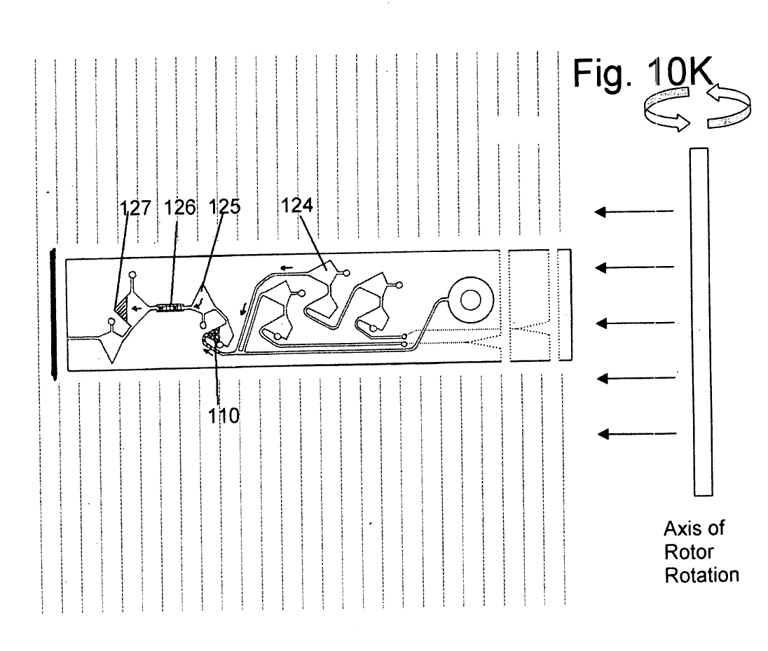

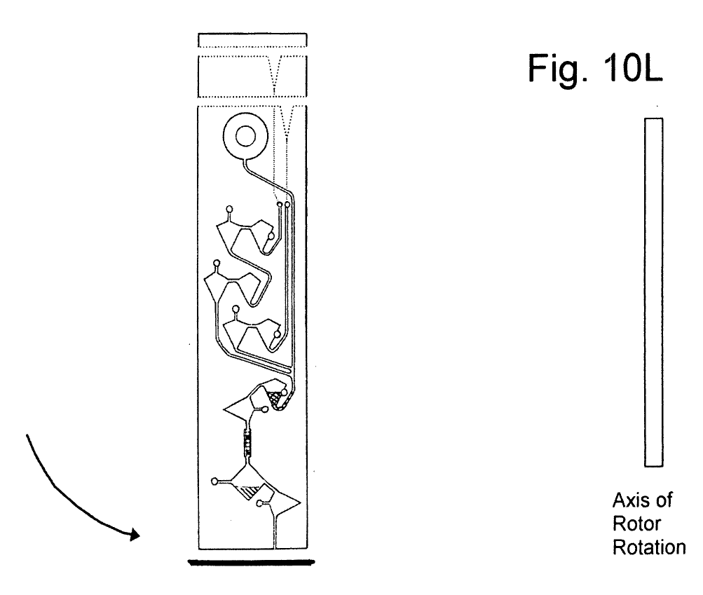

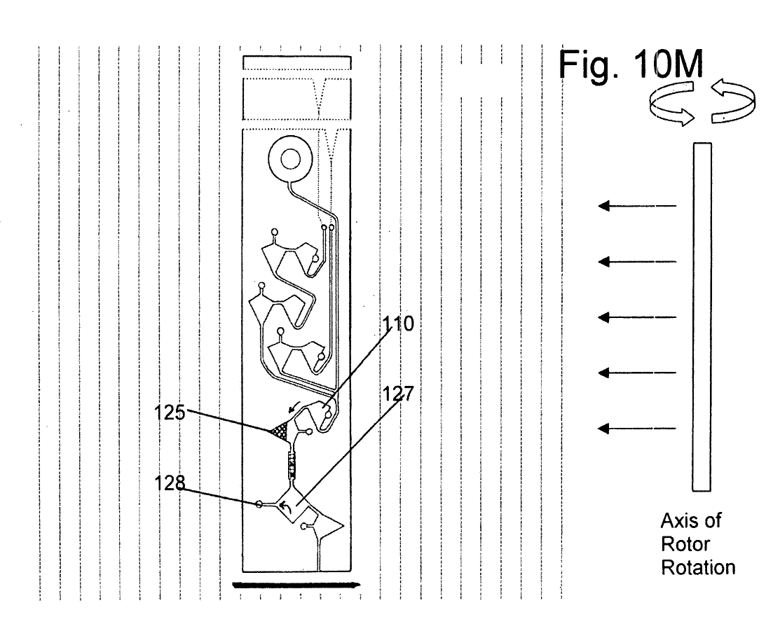

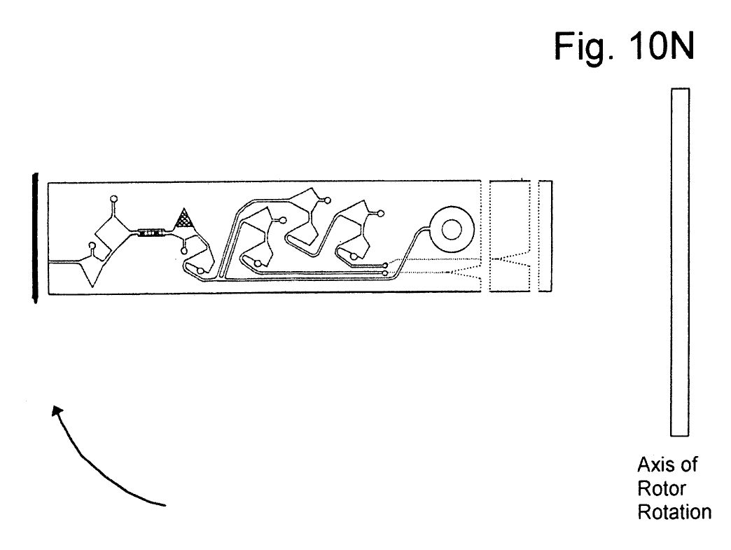

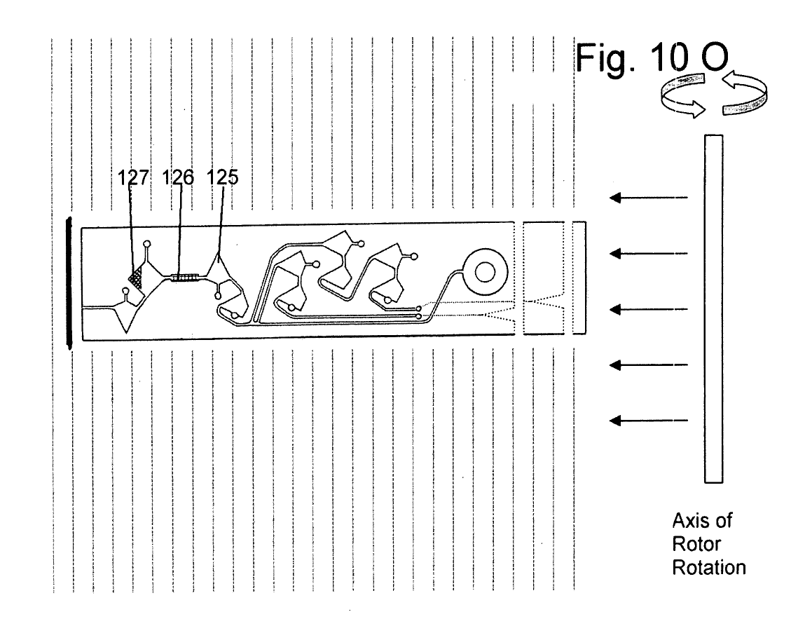

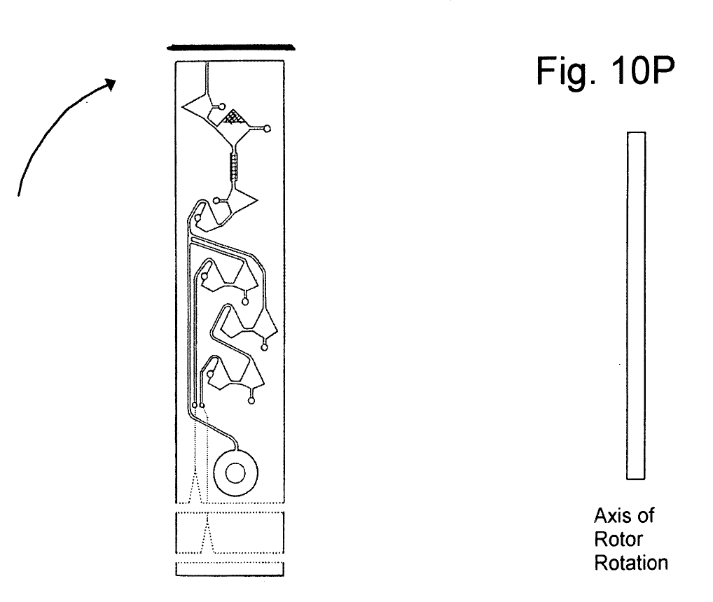

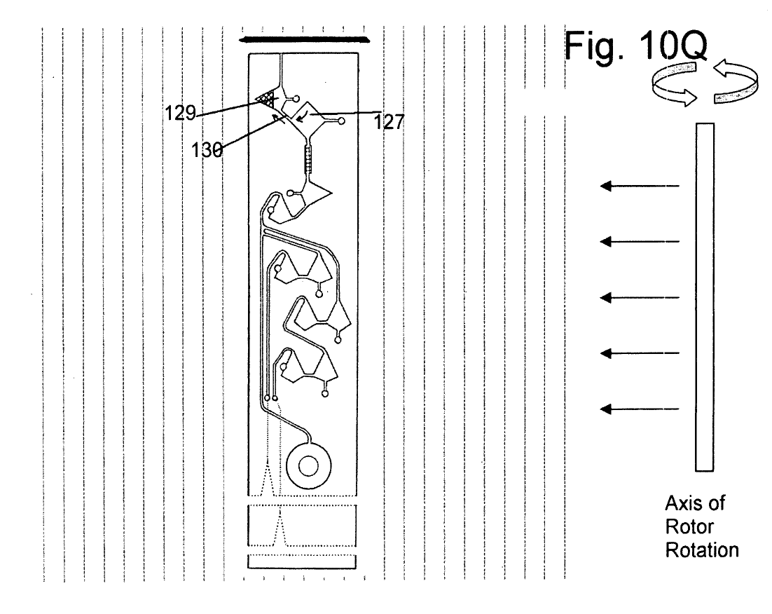

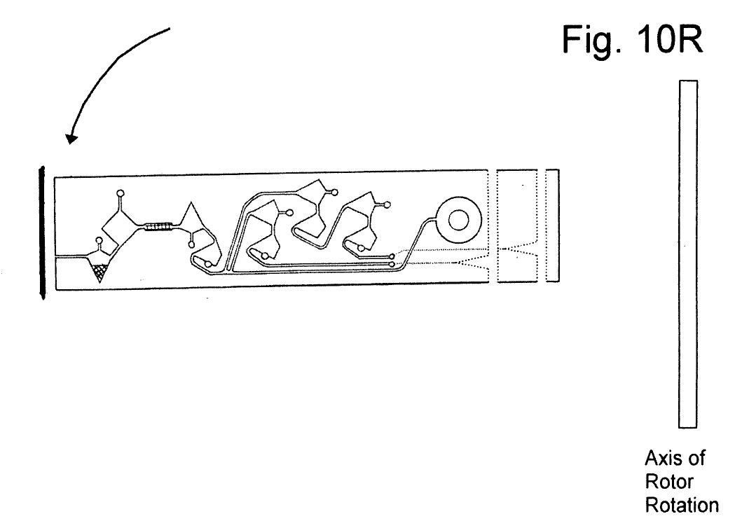

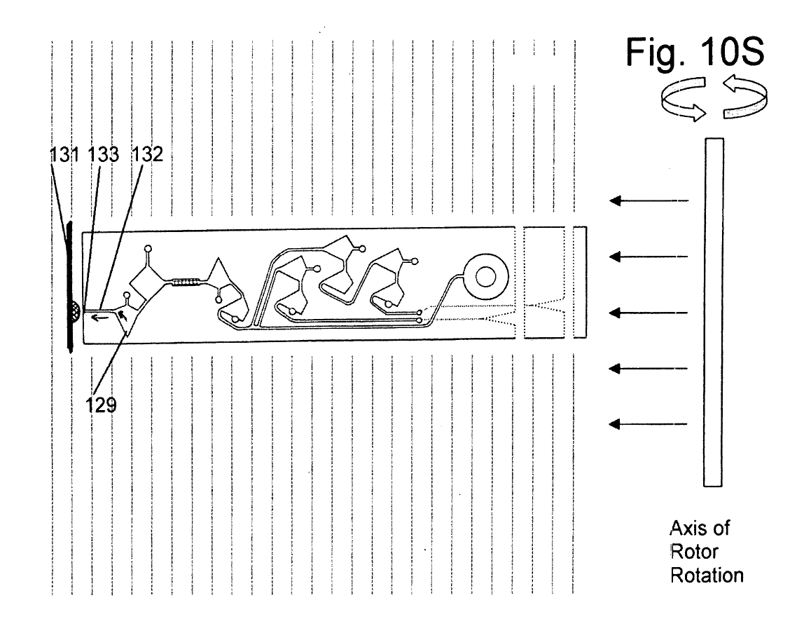

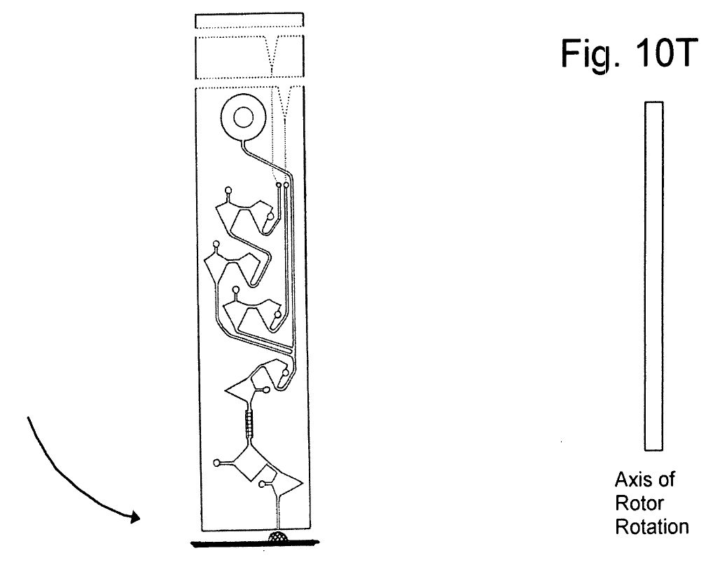

In the plan views that make up FIG. 10A-T, the microfluidic device and MALDI target plate are positioned on a rotatable platform by means of clamp mechanisms or the like (not shown). In FIG. 10A, the rotor (not shown) is in a stopped position with the device and MALDI plate 131 oriented in the position shown relative to the rotor's axis of rotation. An undetermined volume of unpurified protein solution is added to sample chamber 107; undetermined volumes of wash buffer and matrix solution are added to their common reservoirs (not shown). Moving to FIGS. 10B and 10C, the effect is seen when the rotor is accelerated to 1000 rpm or thereabouts to accomplish the first cycle of operation, the metering of sample, wash buffer and matrix solution. As shown in FIG. 10B, upon acceleration of the rotor, wash buffer enters wash buffer distribution channel 108, matrix solution enters matrix solution distribution channel 109 and sample in chamber 107 begins to enter sample channel 111. Referring to FIG. 10C, as the rotor continues to spin, sample is forced through sample channel 111 radially outward from the axis of rotation to chamber 110 and to overflow channel 112 and to the common waste chamber thereby defining a specified volume of sample in chamber 110, typically between 3-10 μL depending upon the requirements of the application. At the same time, wash buffer is forced through channel 118, through through-hole 117 and through channel 115 to chamber 114 with excess wash buffer proceeding through overflow channel 116 to the common waste chamber. The resulting metered volume of wash solution remains in chamber 114, typically between 2-5 μL depending upon the specific requirements of the application. Simultaneous to this operation, matrix solution is forced through channel 123, through through-hole 122 and through channel 120 to chamber 119 with excess matrix solution proceeding through overflow channel 121 to the common waste chamber. The resulting metered volume of matrix solution, typically between 05. to 2 μL depending upon the application, remains in chamber 119.

FIG. 10D shows the rotor stopped and the position of the device segment and fluid contained therein after the platform is rotated −90° relative to the prior orientation of the device. Upon acceleration of the rotor to approximately 1000 rpm as shown in FIG. 10E, sample is moved to vented holding chamber 125 while wash buffer and matrix solution are moved to adjoining delay chambers 124. The rotor is decelerated to a stopped position and the device is reoriented +90° as shown in FIG. 10F. In FIG. 10G, the rotor is accelerated to 1000 rpm or thereabouts and sample is forced from holding chamber 125 through mini column 126 where analyte from the protein digest attaches to the separation media contained therein; the remaining liquid sample proceeding to distribution chamber 127. Simultaneously during this operation, wash buffer is forced from delay chamber 124 through interconnection channels as shown to chamber 110; matrix solution is forced from the first delay chamber 124 through an interconnecting channel to a second delay chamber 124. The rotor is again decelerated to a stop and the device is reoriented 90° in the direction show in FIG. 10H.

Upon acceleration to approximately 1000 rpm as illustrated in FIG. 10I, the sample excluding the portion bound to the mini column media is forced from distribution chamber 127 to the waste chamber through channel 128 connected to a through-hole and channel leading to the waste chamber. At the same time, wash buffer is moved into holding chamber 125 from chamber 110 and matrix solution is forced into a third delay chamber 124. Following this operation, the rotor is again stopped and the platform is rotated +90° as shown in FIG. 10J. The rotor is accelerated to approximately 1000 rpm as illustrated in FIG. 10K whereupon wash buffer is transferred from holding chamber 125, through mini column 126 where unbound analyte is washed from the purification media contained therein, and to distribution chamber 127. At the same time, matrix solution is transferred under the influence of centrifugal force from delay chamber 124 and through interconnecting channels to chamber 110. FIG. 10L shows the next step in the operating sequence in which the rotor is stopped and the platform is rotated 90° in the direction shown. Upon acceleration to 1000 rpm or thereabouts as shown in FIG. 10M, wash buffer that had previously removed unbound material from the mini column is forced from distribution chamber 127 to waste channel 128 and to the common waste channel. Simultaneously, matrix solution is forced from chamber 110 to holding chamber 125 in preparation for the next sequence of operation. In FIG. 10N, the device is reoriented 90° in the direction shown. Upon acceleration to approximately 1000 rpm, matrix solution is forced from holding chamber 125 through mini column 126 where analyte previously bound to the purification media is eluted by the matrix solution. The resulting matrix/analyte mixture then proceeds to distribution chamber 127.

FIG. 10P shows the position of the device once the rotor is stopped and the platform is rotated 90° in the direction shown. The rotor is again accelerated to 1000 rpm or thereabouts and the matrix/analyte mixture, typically a precise volume of 0.5 to 2 μL, is forced from distribution chamber 127 to vented holding chamber 129 through interconnecting channel 130. The rotor is then decelerated to a stop and the device is reoriented 90° in the direction shown in FIG. 10R. Upon acceleration of the rotor to 1000 rpm or thereabouts, the matrix/analyte mixture is forced under the influence of centrifugal force from holding chamber 129, through channel 132 to device outlet 133. The 0.5 to 2 μL of matrix solution is then dispensed by the action of centrifugal force onto the target area of the MALDI target plate 131. The spot of matrix/analyte solution is held in place on the MALTI target plate by surface tension as the rotor is stopped the device is reoriented to the rest position as shown in FIG. 10T. The device and MALDI target plate are then removed from the centrifuge unit and the device is disposed of. The matrix/analyte spots on the MALDI target produced by the device segments are allowed to evaporate to expose the analyte crystals prior to placing the target plate into a MALDI mass spectrometer for analysis.

One skilled in the art will be aware that numerous variations may be made in specific embodiments within the scope of the claims as set out below. The illustrations supplied above illustrate the best mode known to the inventor for practice of his invention and are not intended as limitation of the invention disclosed.

1. A method for moving a fluid sample within an open channel flow device by centrifugal force which comprises providing a planar platform having a plurality of chambers, having a first chamber with a plane, a fluid passage in the plane of the plurality of chambers, each fluid passage having a first and a second end, the first end in fluid communication with the first chamber a second chamber in fluid communication with the second end of the fluid passage, and a second fluid passage in the plane of the plurality of chambers having a first and a second end the first end in fluid communication with the second chamber and a third chamber in fluid communication with the second end of the second fluid passage, the position or shape of each fluid passage creating a flow restricting action in a first position and a flow enhancing action in a second position by reorientation of the platform while connecting the first second and third chambers to enable sequential movement of a fluid from the first chamber to the second chamber in a first orientation of the platform such that centrifugal force is applied in a flow enhancing direction to move fluid through the first passage from the first chamber to the second chamber and following a change in orientation of the platform to enable further movement of the fluid from the second chamber to the third chamber, placing the open channel flow device in a centrifuge, positioning the open channel flow device such that a fluid placed in the first chamber will not move by centrifugal force from the first chamber to the second chamber when the open channel flow device is a first position stopping the application of centrifugal force and thereafter positioning the open channel flow device in a second position wherein fluid moves from the first chamber to the second chamber during operation of the centrifuge, the second position being achieved by rotation of the planar platform around an axis of rotation placed at an angle greater than zero to the plane of the platform, applying a centrifugal force to the platform for sufficient time to move the fluid from the first chamber to the second chamber, stopping the application of centrifugal force, thereafter positioning the open channel flow device in a third position such that the fluid in the second chamber will move by centrifugal force from the second chamber to the third chamber, and applying a centrifugal force for sufficient time to move the fluid from the second chamber to the third chamber, the third position being achieved by rotation of the planar platform around an axis of rotation placed at an angle greater than zero to the plane of the platform.

2. The method of claim 1 that comprises providing at least one fluid passage having a shape that increases the time required to move the fluid from one chamber to another over the time required to move the fluid between the same chambers by a passage following the shortest path between the chambers.

3. The method of claim 1 wherein a plurality of chambers and connecting passages are provided such that two fluids are moved to the same chamber.

4. The method of claim 1 wherein at least one chamber is provided that has a shape that increases mixing of two fluids entering the chamber.

5. The method of claim 4 wherein means are provided to position the platform such that a portion of the platform is located at the center of rotation of the centrifuge rotor when the centrifuge is in operation.

6. The method of claim 1 wherein a passage is provided that prevents flow by a size that prevents flow of a fluid through the passage in the absence of a force applied to the fluid in the direction of the passage.

7. The method of claim 1 wherein a passage is provided that prevents flow by the location of the passage relative to the direction of forces acting on the fluid in the chamber in a first position and allows flow when the platform is rotated to a second position relative to forces acting on the fluid.

8. The method of claim 1 wherein the chambers and passages are arranged such that fluid moves sequentially from the first chamber to the second chamber and from the second chamber to the third chamber but the fluid does not move in the reverse sequence from the second chamber to a previously occupied chamber.

9. The method of claim 8 wherein a chamber is provided that is sized to measure a quantity of fluid and a passage is provided to move excess fluid to an additional chamber.

10. The method of claim 9 wherein a passage is provided to move the measured quantity of fluid to a third chamber and means are provided to contact the measured quantity with a substance in the third chamber that produces a change in at least one component of the measured quantity of fluid.

11. The method of claim 1 wherein a passage is provided having a surface in contact with the fluid to be moved that is treated to reduce the attraction between the surface and the fluid.

12. A valve-less fluidic device comprising a centrifuge rotor having mounted there on a platform having a first chamber, a second chamber and a third chamber within a plane, a plurality of fluid passages in same plane as two of the chambers the first, second and third chamber and second chambers, each fluid passage having a first end and a second end, a first fluid passage having the first end in fluid communication with the first chamber and the second end in fluid communication with the second chamber and a second fluid passage being positioned and shaped such that fluid communication is established between the first and second chambers when the platform is placed in a first orientation to the direction of applied centrifugal force and prevents fluid flow when the platform is rotated around its axis at an angle greater than zero to the plane of the fluid passage, to a second position wherein fluid does not flow through the passage when centrifugal force is applied to the platform, and a second fluid passageway having a first end in fluid communication with the second chamber and the second end in fluid communication with the third chamber such that fluid communication is established between the second and third chambers when the platform is placed in a second orientation to the direction of applied centrifugal force and prevents fluid flow form the second chamber to the first chamber when the platform is rotated around its axis at an angle greater than zero to the plane of the fluid passage when centrifugal force is applied to the platform, the device comprising positioning means for fixing the platform in a plurality of positions and means for moving the platform from a first fixed position to a second fixed position when the rotor is at rest, such that changing the orientation of the platform is conducted in the absence of applied centrifugal force.

13. The device of claim 12 having a platform that comprises at least one fluid passage having a shape that increases the time required to move the fluid from one chamber to another over the time required to move the fluid between the same chambers by a passage following the shortest path between the chambers.

14. The device of claim 12 having a platform that comprises a plurality of chambers and connecting passages such that two fluids are moved to the same chamber.

15. The device of claim 12 having a platform that comprises at least one chamber has a shape that increases mixing of two fluids entering the chamber.

16. The device of claim 15 comprising means to position a platform such that a portion of the platform is located at the center of rotation of the centrifuge rotor when the centrifuge is in operation.

17. The device of claim 12 having a platform that comprises a passage that prevents flow by having a size that prevents flow of a fluid through the passage in the absence of a force applied to the fluid in the direction of the passage.

18. The device of claim 12 having a platform that comprises a passage that prevents flow by the location of the passage relative to the direction of forces acting on the fluid in the chamber in a first position and allows flow when the platform is rotated to a second position relative to forces acting on the fluid.

19. The device of claim 12 having a platform that comprises chambers and passages that are arranged such that fluid moves sequentially from the first chamber to the second chamber and from the second chamber to the third chamber but the fluid does not move in the reverse sequence from the second chamber to a previously occupied chamber regardless of subsequent orientations of the device.

20. The device of claim 12 having a platform that comprises a chamber is sized to measure a quantity of fluid and a passage to move excess fluid to an additional chamber.

21. The device of claim 12 having a platform that comprises a passage to move the measured quantity of fluid to a third chamber and means to contact the measured quantity with a substance in the third chamber that produces a change in at least one component of the measured quantity of fluid.

22. The device of claim 12 that comprises a passage having a surface in contact with the fluid to be moved that is treated to reduce the attraction between the surface and the fluid

23. A centrifuge for applying centrifugal force to a device comprising a rotor adapted to house a valve free device comprising a platform having at least three chambers within a plane, at least two fluid passages in same plane as at least two of the chambers each fluid passage having a first end and a second end, the first end being in fluid communication with a first chamber, and the second end of the fluid passage being in fluid communication with a second chamber each fluid passage being positioned and shaped such the fluid communication is established between the first and second chambers when the platform is placed in a first orientation to the direction of applied centrifugal force and preventing fluid communication when the platform is rotated around its axis at an angle greater than zero to the plane of the fluid passage to a second position wherein fluid does not flow through the passage when centrifugal force is applied to the platform, and means to stop the rotor, means to reposition the platform by rotating the platform from a first position to a second position when the rotor is at rest.

24. The centrifuge of claim 23 having a platform that comprises at least one fluid passage having a shape that increases the time required to move the fluid from one chamber to another over the time required to move the fluid between the same chambers by a passage following the shortest path between the chambers.

25. The centrifuge of claim 23 having a platform that comprises a plurality of chambers and connecting passages such that two fluids are moved to the same chamber.

26. The centrifuge of claim 23 having a platform that comprises at least one chamber has a shape that increases mixing of two fluids entering the chamber.

27. The centrifuge of claim 23 having means to position a platform such that a portion of the platform is located at the center of rotation of the centrifuge rotor when the centrifuge is in operation.

28. The centrifuge of claim 23 having a platform that comprises a passage that prevents flow by having a size that prevents flow of a fluid through the passage in the absence of a force applied to the fluid in the direction of the passage.

29. The centrifuge of claim 23 having a platform that comprises a passage that prevents flow by the location of the passage relative to the direction of forces acting on the fluid in the chamber in a first position and allows flow when the platform is rotated to a second position relative to forces acting on the fluid.

30. The centrifuge of claim 23 having a platform that comprises chambers and passages that are arranged such that fluid moves sequentially from the first chamber to the second chamber and from the second chamber to the third chamber but the fluid does not move in the reverse sequence from the second chamber to a previously occupied chamber regardless of subsequent orientations of the device.

31. The centrifuge of claim 23 having a platform that a chamber sized to measure a quantity of fluid and a passage to move excess fluid to an additional chamber.

32. The centrifuge of claim 23 having a platform that comprises a passage to move the measured quantity of fluid to a third chamber and means to contact the measured quantity with a substance in the third chamber that produces a change in at least one component of the measured quantity of fluid.

33. The centrifuge of claim 23 having a platform that comprises a passage having a surface in contact with the fluid to be moved that is treated to reduce the attraction between the surface and the fluid.
